(19) United States
(12) Patent Application Publication
(10) Pub. No.: US 2014/0045159 A1
(43) Pub. Date: Feb. 13, 2014

(54) Using Conditional Logic to Provide an Online Health Assessment

(71) Applicant: Usana Health Sciences, Inc., Salt Lake City, UT (US)

(72) Inventors: David A. Wentz, Park City, UT (US); Brian Dixon, Salt Lake City, UT (US)

(73) Assignee: Usana Health Sciences, Inc., Salt Lake City, UT (US)

(21) Appl. No.: 13/964,871

(22) Filed: Aug. 12, 2013

Related U.S. Application Data
(60) Provisional application No. 61/682,108, filed on Aug. 10, 2012.

(51) Int. Cl. G09B 19/00

(52) U.S. Cl. CPC G09B 19/00
USPC 434/247

(57) ABSTRACT

The present invention extends to methods, systems, and computer program products for providing an online health assessment. The online health assessment collects information from an individual and applies conditional logic to the collected information to identify information to be included in a lifestyle, nutrition, and/or product plan for the individual.

### CROSS-REFERENCE TO RELATED APPLICATIONS

This U.S. Patent Applications claims priority to U.S. Provisional Patent Application No. 61/682,108, filed Aug. 10, 2012, titled Using Conditional Logic to Provide an Online Health Assessment.

### BACKGROUND

With the fast pace of life today, many people find it difficult to maintain or improve their health. Even if a person has the desire to improve his health, he may not be aware of what changes are required to make the desired improvement. For example, a person may desire to simply feel better but may not know what factors may be preventing him from feeling as he desires.

Even when a person knows what general changes need to be made in his lifestyle to make a desired improvement, he may not know how to bring about the necessary changes. There are often many different factors that affect a person's desire or ability to make changes to his lifestyle. A person may be overwhelmed by these factors and may be unable to identify which factors may be the most beneficial to address Similarly, a person may be unable to identify particular factors or areas that pose the greatest risk to future health.

### BRIEF SUMMARY

The present invention extends to methods, systems, and computer program products for providing an online health assessment. The online health assessment collects information from an individual and applies conditional logic to the collected information to identify information to be included in a lifestyle plan for the individual.

In one embodiment, a method is performed for using conditional logic to identify relevant information to include in a lifestyle, nutrition, and/or product plan of an individual. Values are received for a plurality of factors used by the conditional logic to identify relevant information for an individual. The received values are based on the individuals input to an online health assessment. The conditional logic is applied to the values to identify whether a particular piece of information is to be included in the lifestyle, nutrition, and/or product plan. Different portions of the conditional logic are applied to different combinations of values. For each portion of conditional logic for which the corresponding combination of values is true, a corresponding piece of information is included in the lifestyle, nutrition, and/or product plan.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary networked environment in which the present invention can be implemented;

FIGS. 2A-2H illustrate various exemplary views of an online health assessment user interface;

FIGS. 3A-3C illustrate a portion of a risk area assessment;

FIGS. 4A-4C illustrate a portion of an exemplary lifestyle plan and

FIG. 5 illustrates a flowchart of an exemplary method for using conditional logic to identify relevant information to include in a lifestyle plan of an individual.

### DETAILED DESCRIPTION

The present invention extends to methods, systems, and computer program products for providing an online health assessment. The online health assessment collects information from an individual and applies conditional logic to the collected information to identify information to be included in a lifestyle plan for the individual.

In one embodiment, a method is performed for using conditional logic to identify relevant information to include in a lifestyle, nutrition, and/or product plan of an individual. Values are received for a plurality of factors used by the conditional logic to identify relevant information for an individual. The received values are based on the individuals input to an online health assessment. The conditional logic is applied to the values to identify whether a particular piece of information is to be included in the lifestyle, nutrition, and/or product plan. Different portions of the conditional logic are applied to different combinations of values. For each portion of conditional logic for which the corresponding combination of values is true, a corresponding piece of information is included in the lifestyle, nutrition, and/or product plan.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

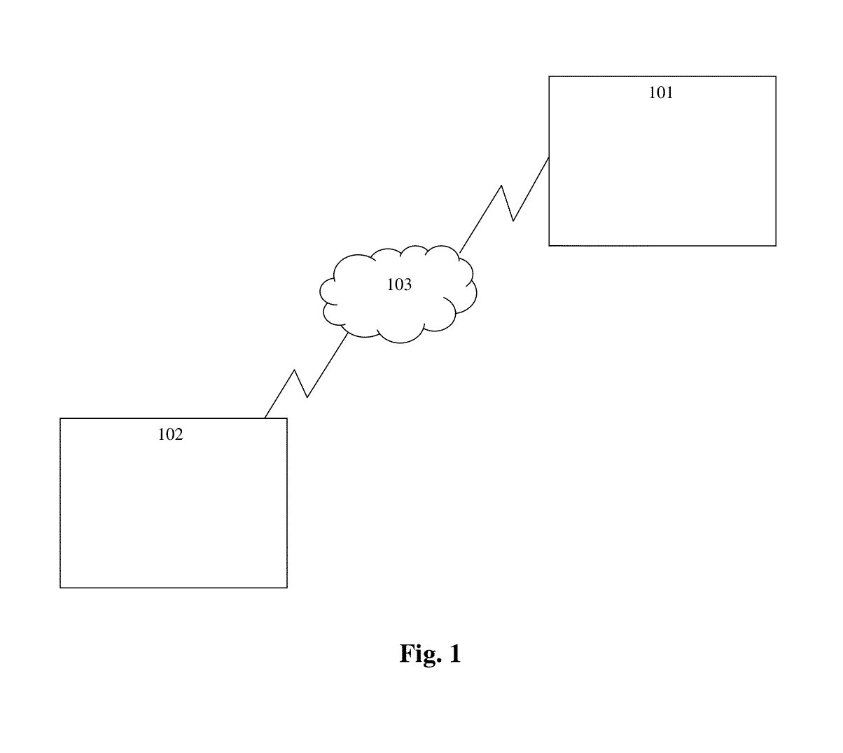

FIG. 1 illustrates an exemplary networked environment 100 in which the present invention can be implemented. Networked environment 100 includes computer system 101, computer system 102, and network 103. Network 103 can represent the internet and any of the various means of connecting to the internet. Accordingly, computer system 102 generally connects to computer system 101 via the internet although any other network could also be used.

Computer system 101 represents a computer system used by a provider of an online health assessment. Computer system 101 can therefore be one or more computer systems functioning as servers (including a cluster of servers (e.g. a cloud)), or any other computer system capable of communicating with computer system 102 to provide an online health assessment.

Computer system 102 represents the computer system used by a user to take the online health assessment provided by computer system 101. Accordingly, computer system 102 could be a tablet, laptop, or desktop computer, a mobile phone, or any other computer system capable of communicating with computer system 101 as further described below.

Although FIG. 1 depicts two computer systems communicating over a network to implement the online health assessment, the online health assessment could also be provided on a single system. For example, a mobile application can be installed on a mobile device which can provide an online health assessment as described below. In such cases, the mobile device (or other computer system) may or may not communicate with computer system 102 during the online health assessment (e.g. the mobile application may contain all the necessary logic to identify risk areas based on user input during the online health assessment). Accordingly, the present invention is not limited to any particular computer architecture.

According to embodiments of the invention, an online health assessment can be provided that requests information from an individual and applies conditional logic to received information to identify what pieces of information to include in a lifestyle, nutrition, and/or product plan for the individual.

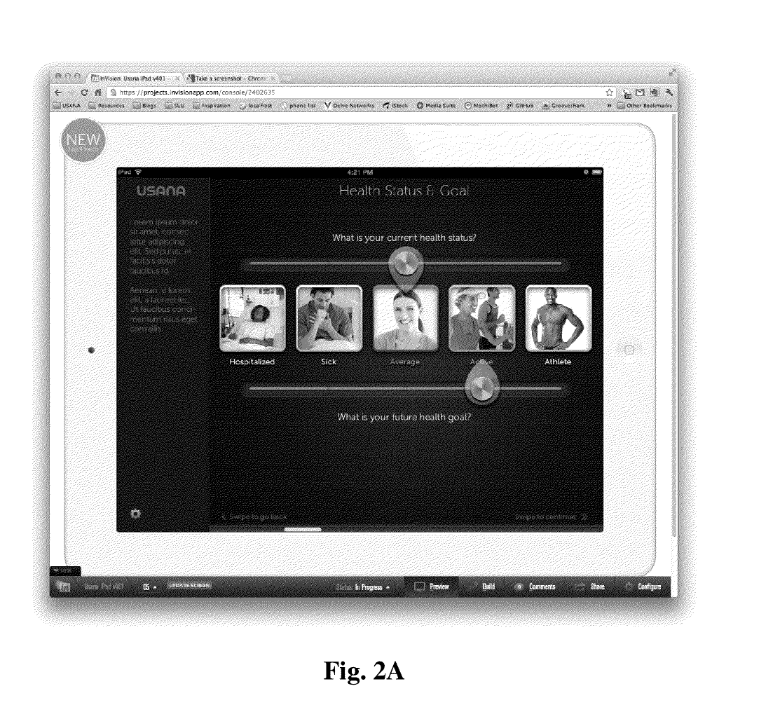

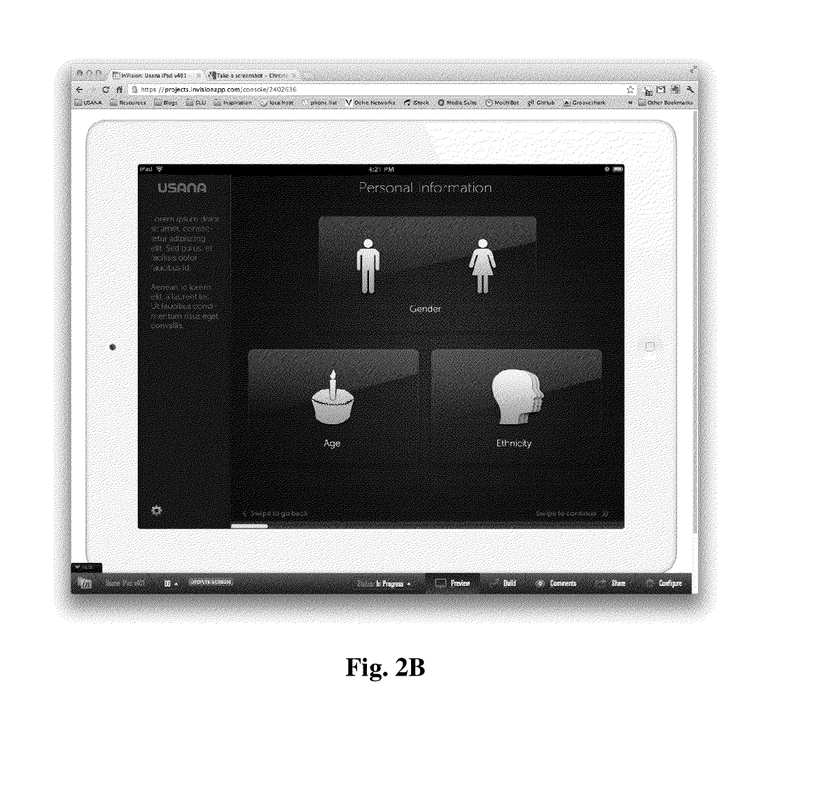

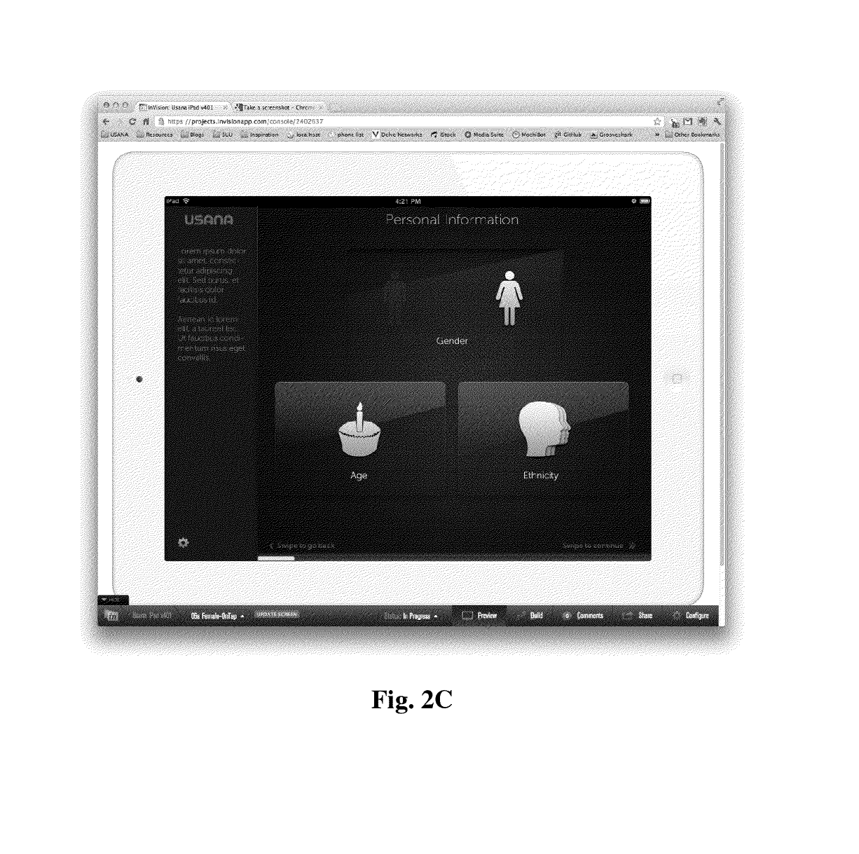

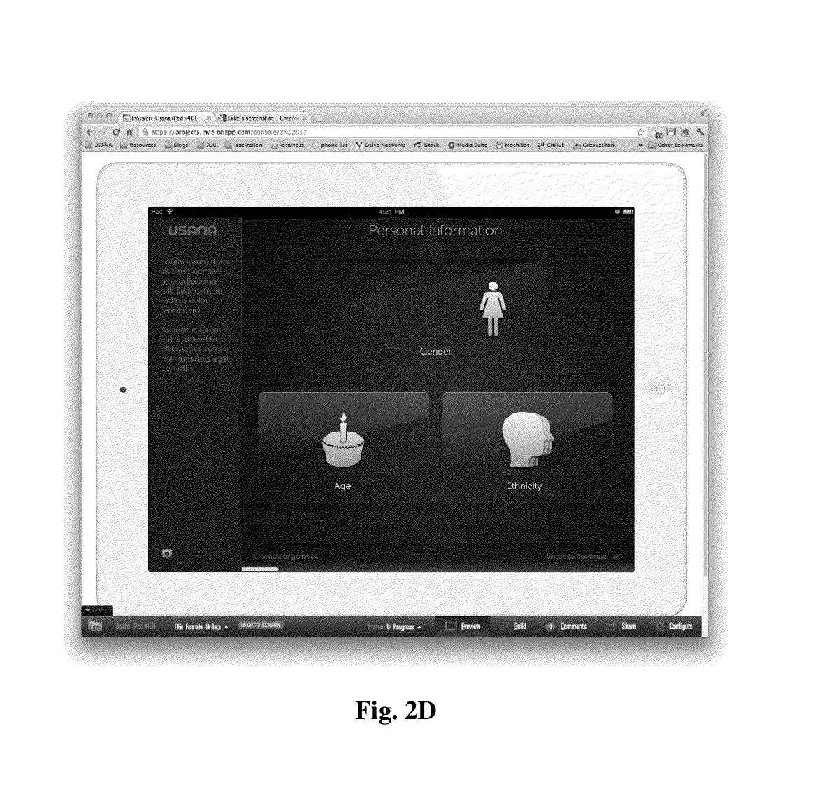

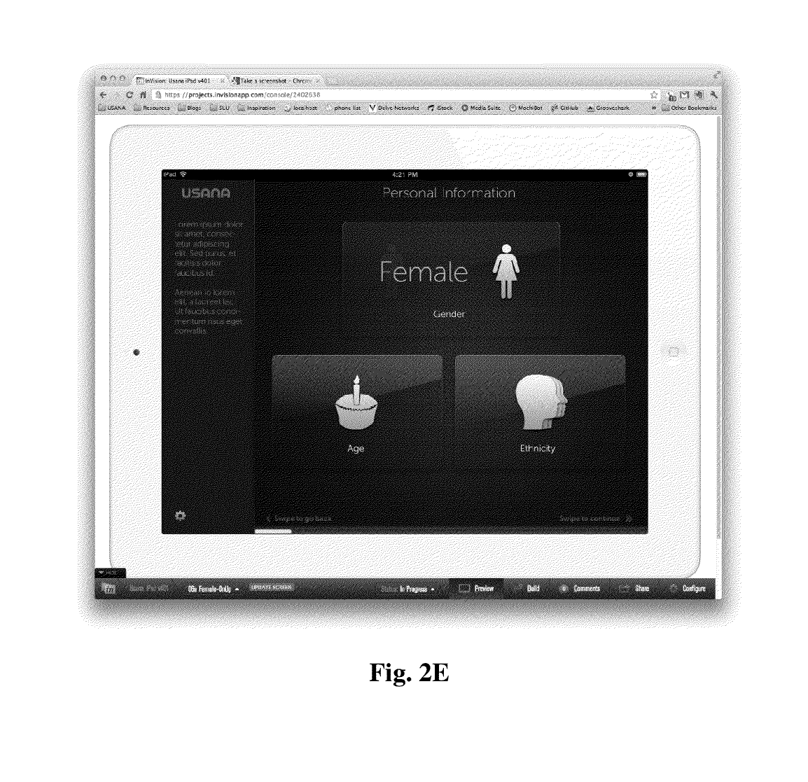

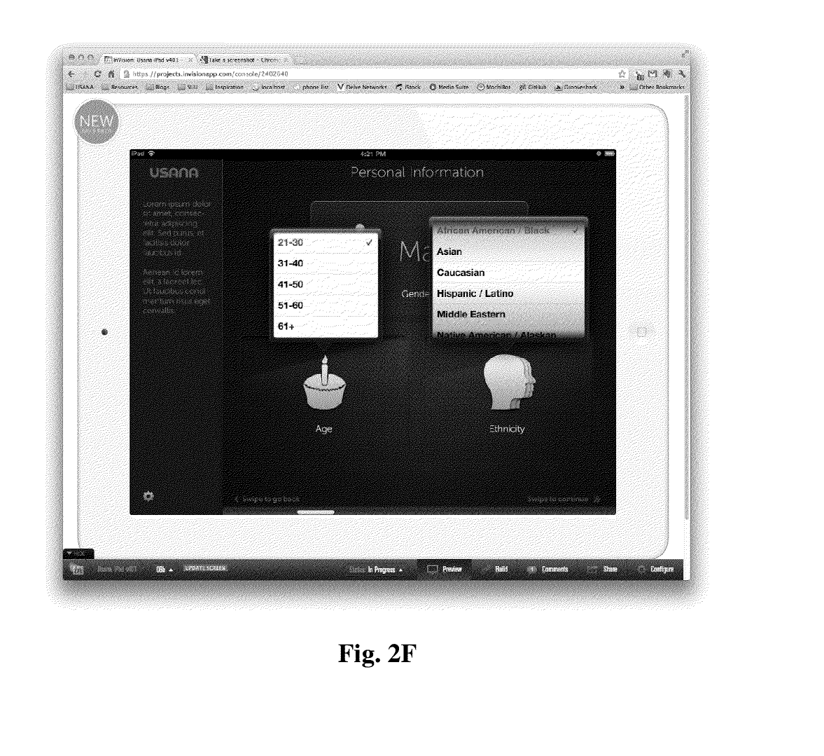

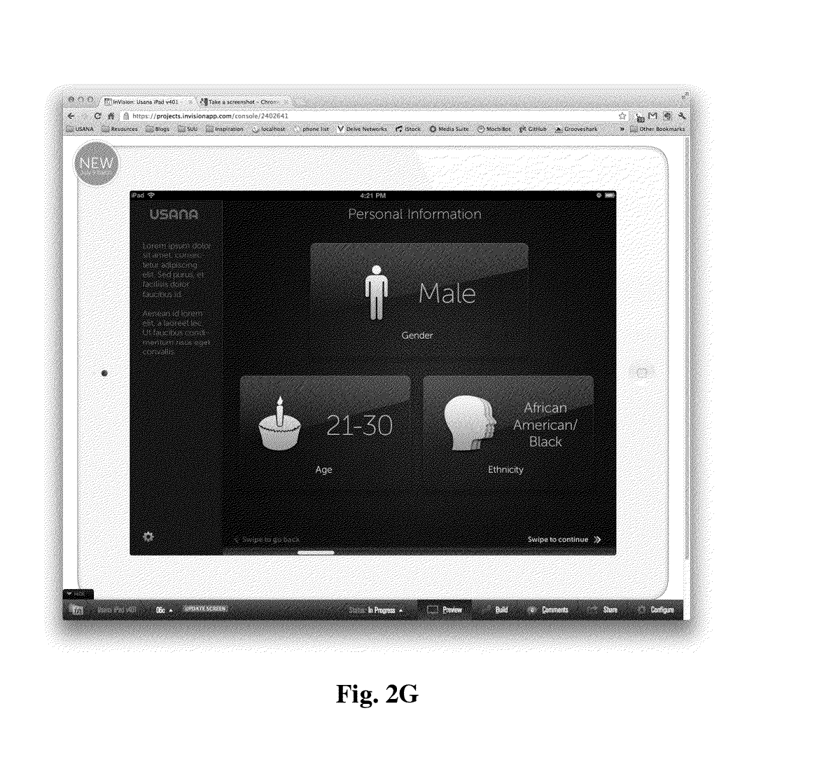

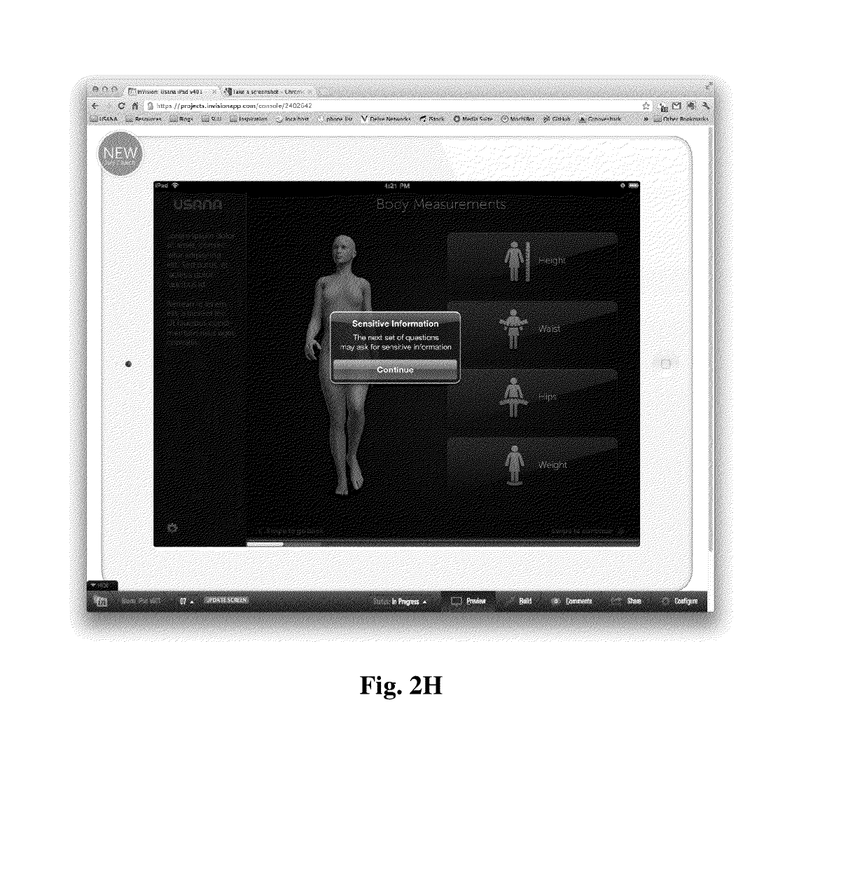

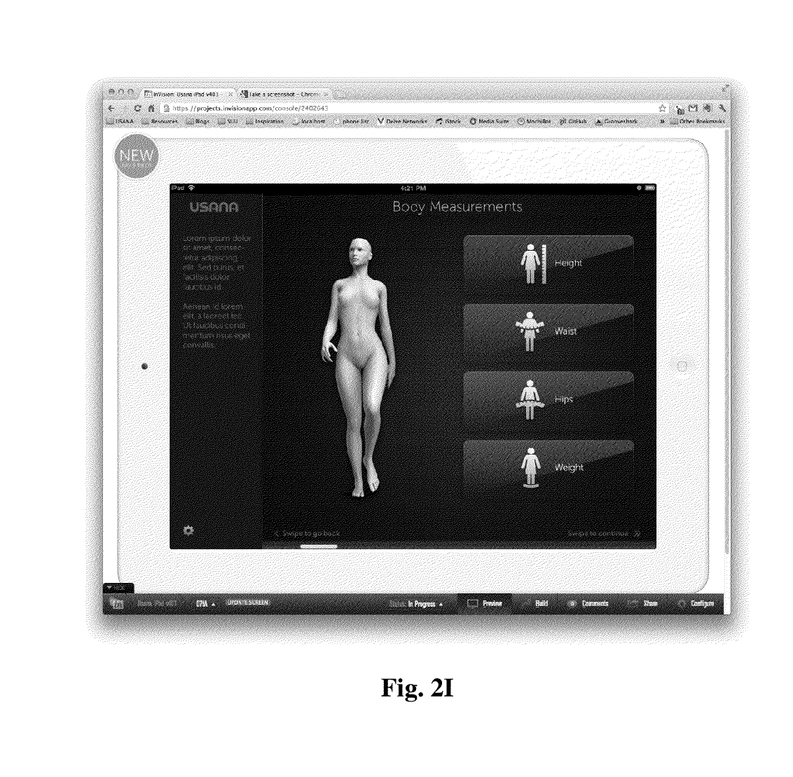

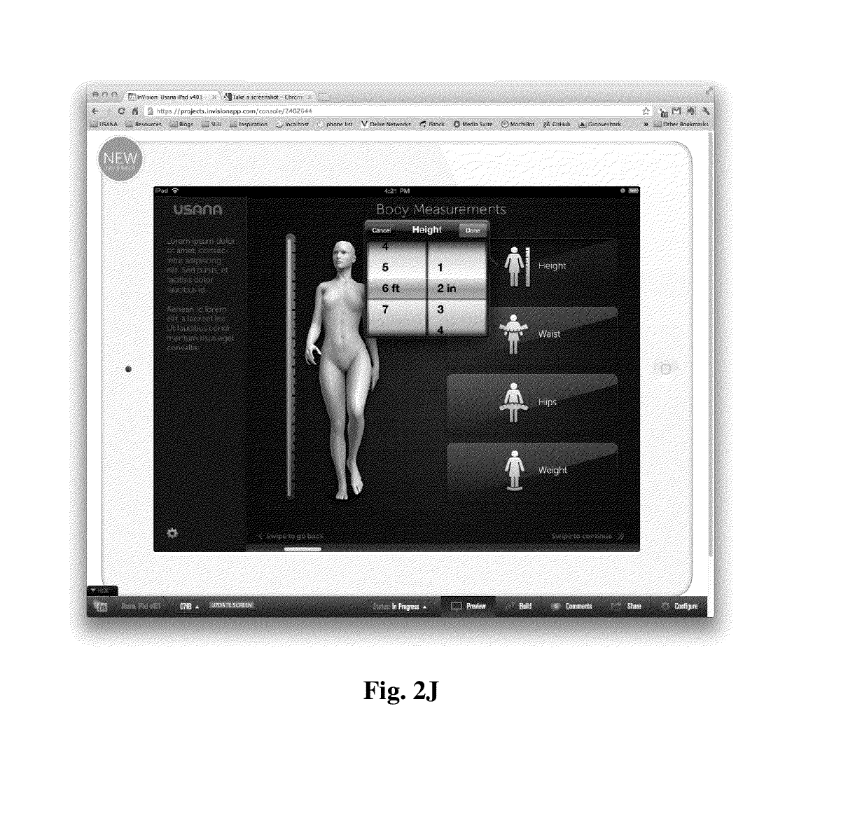

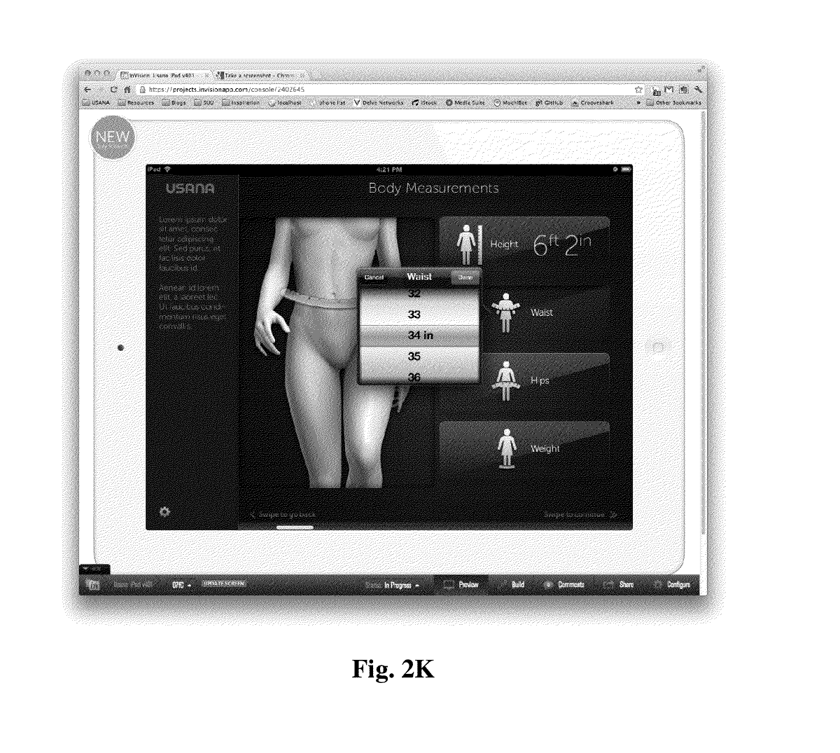

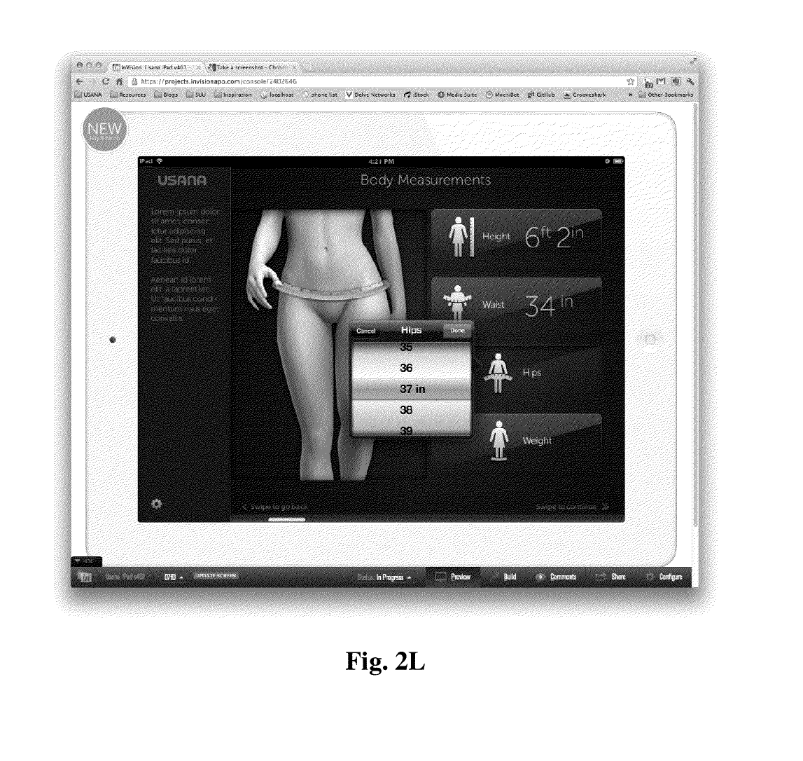

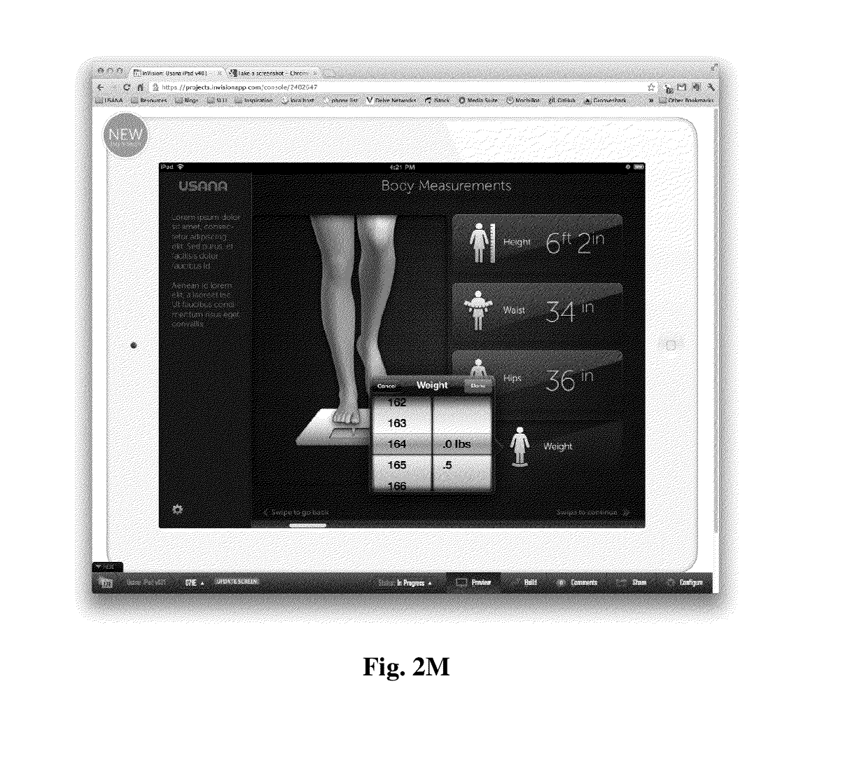

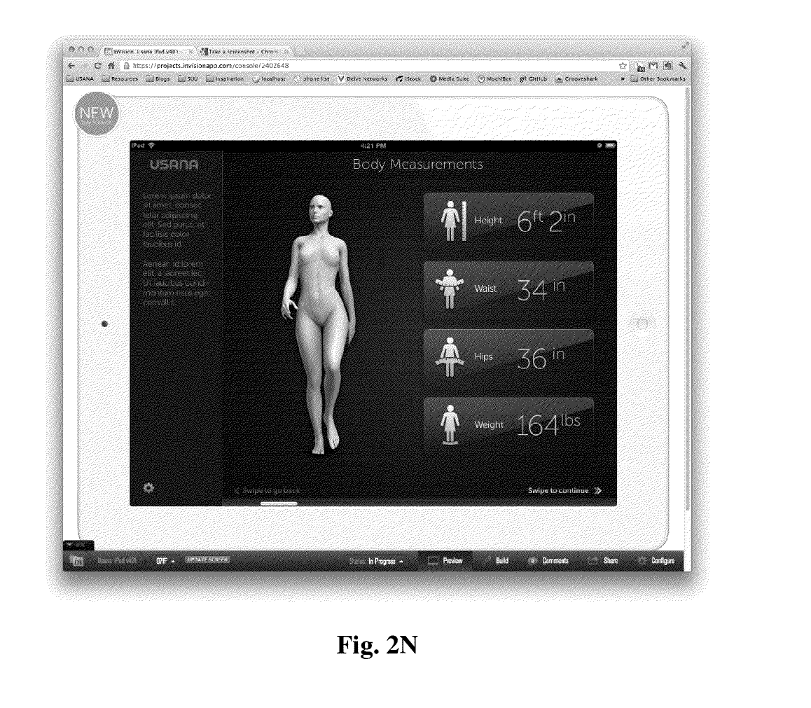

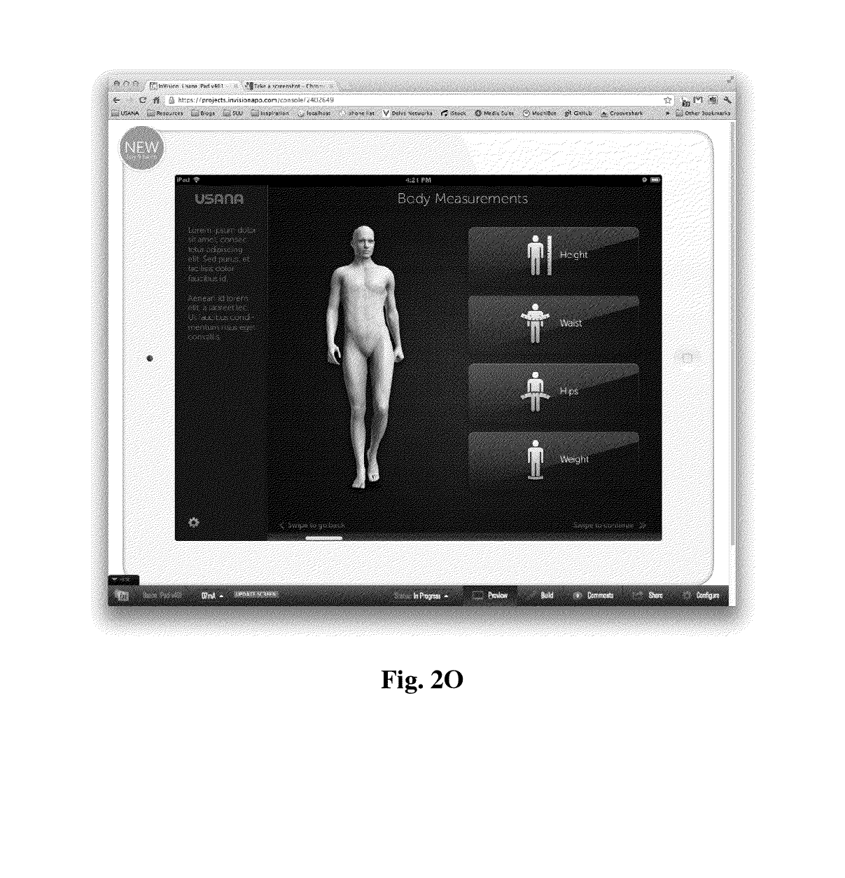

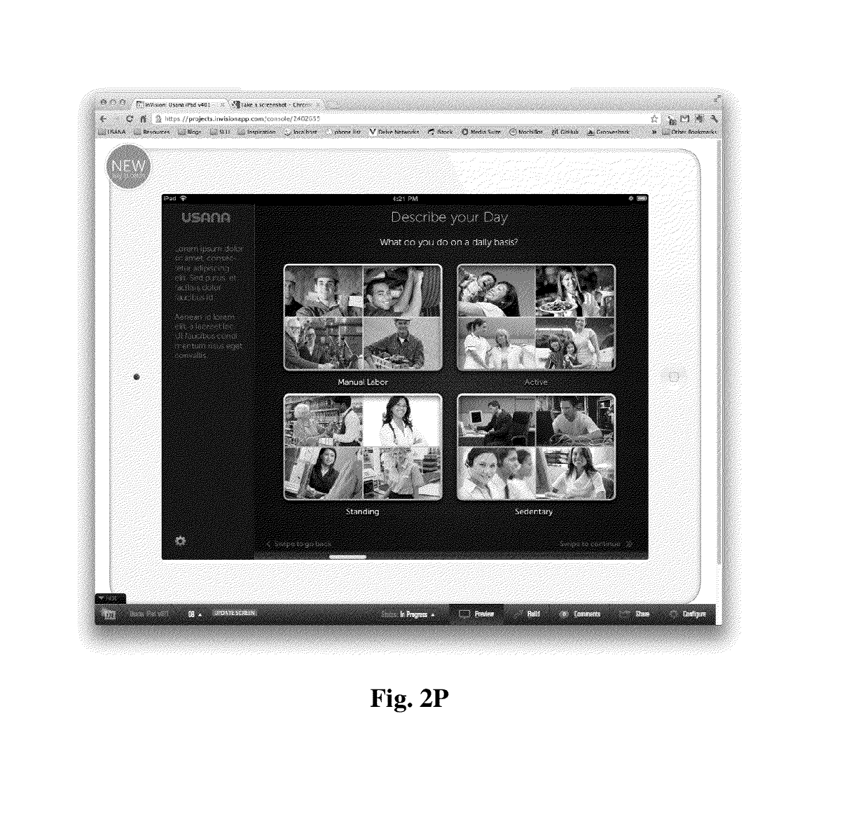

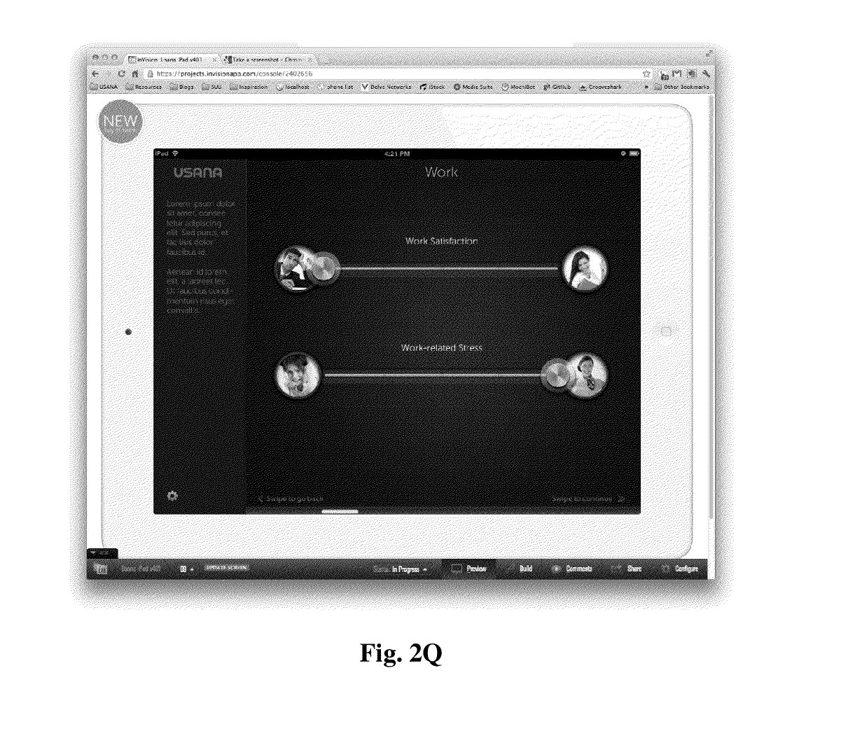

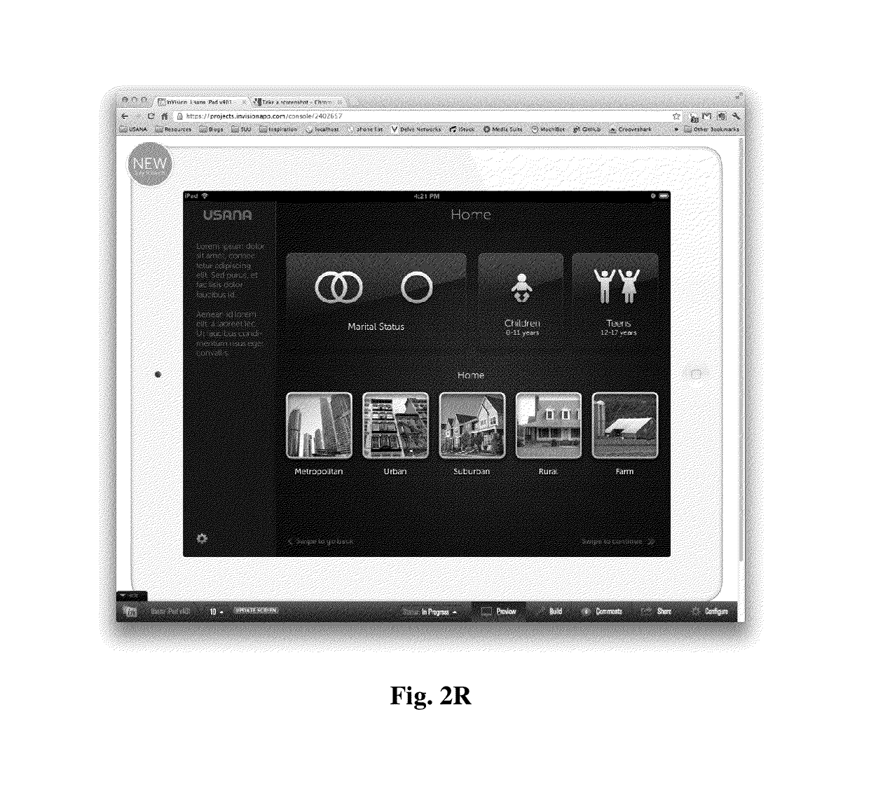

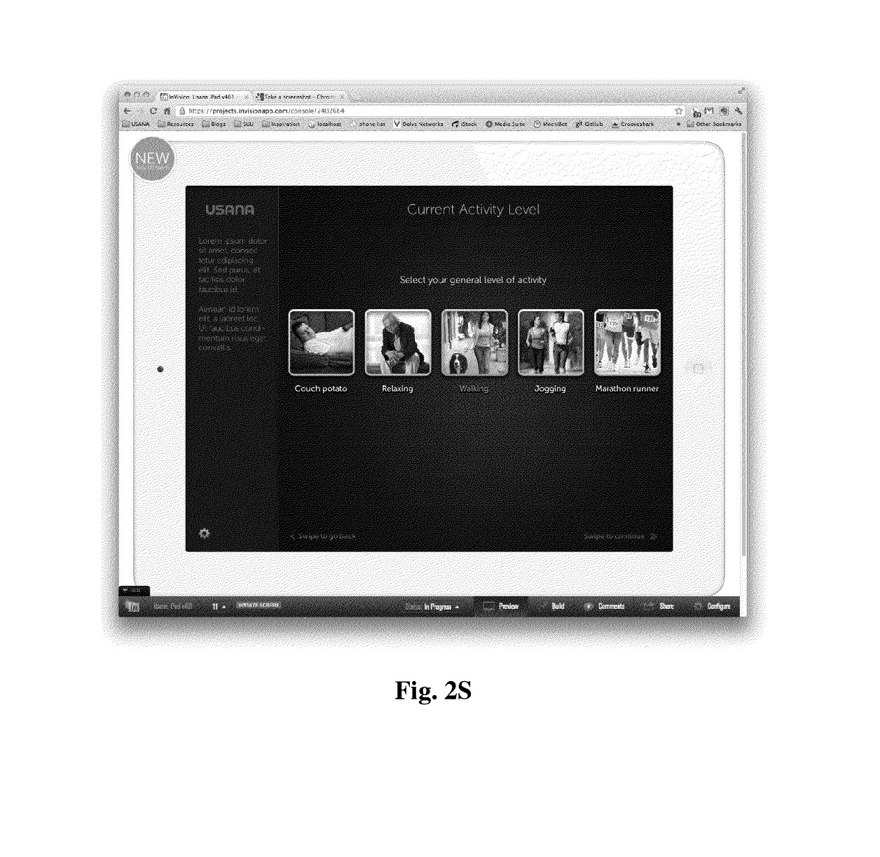

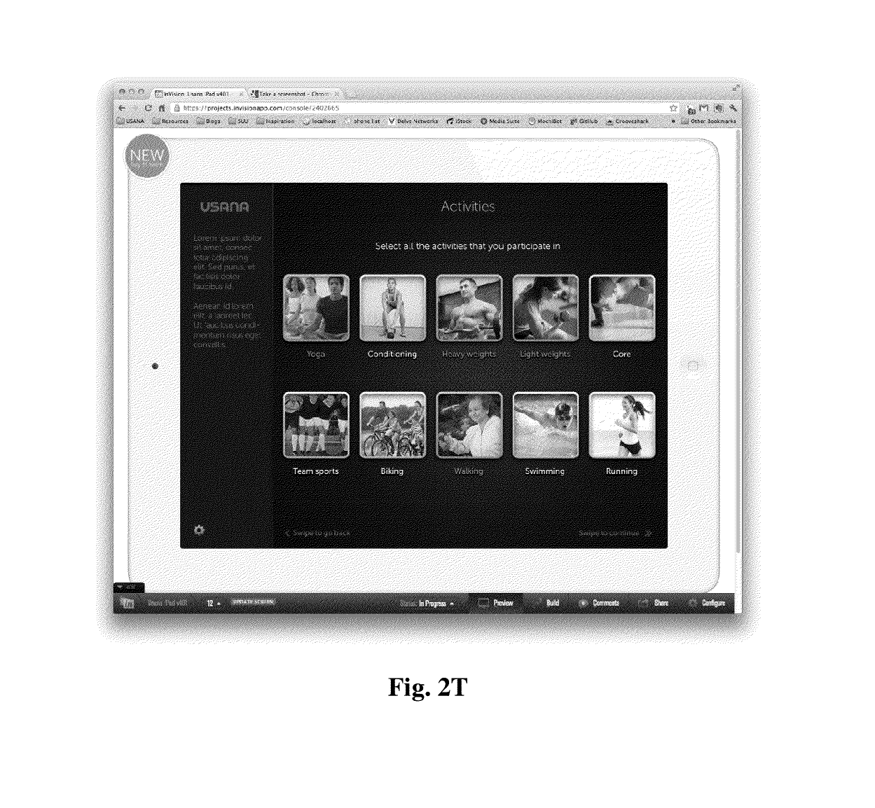

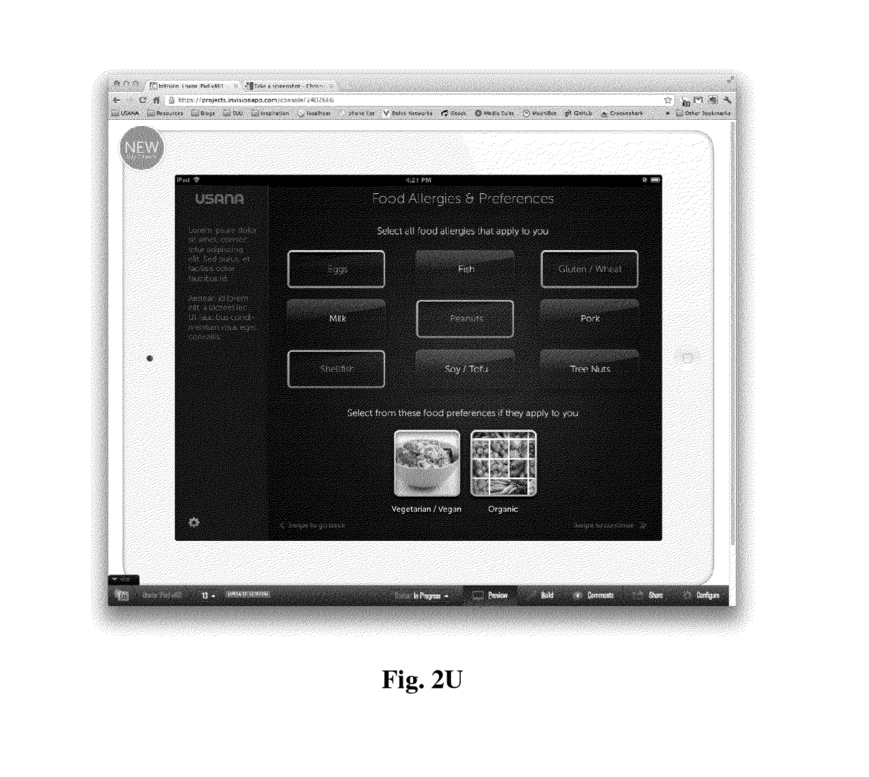

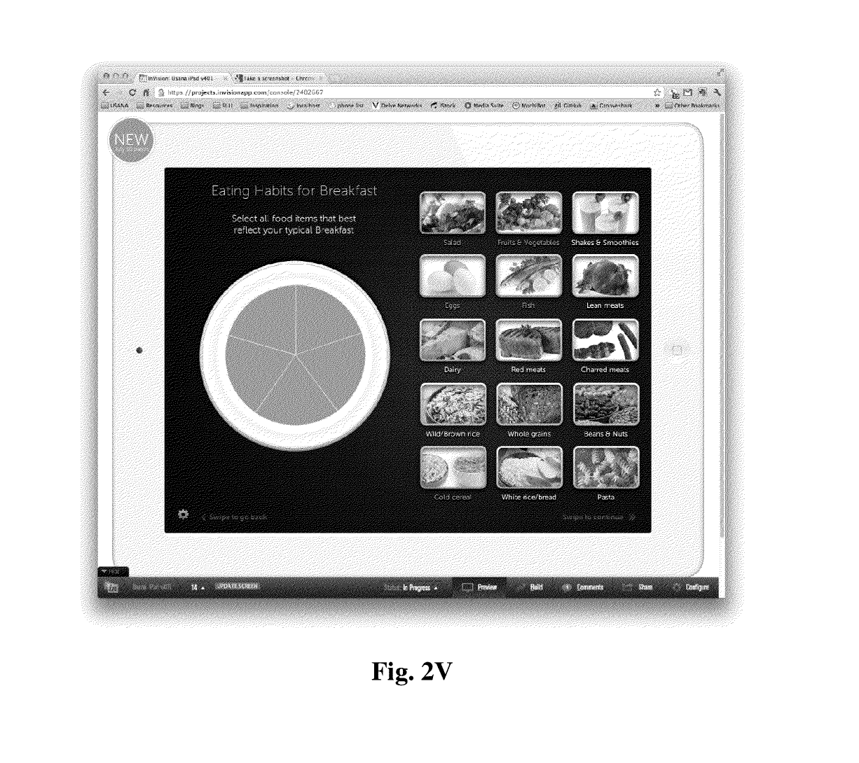

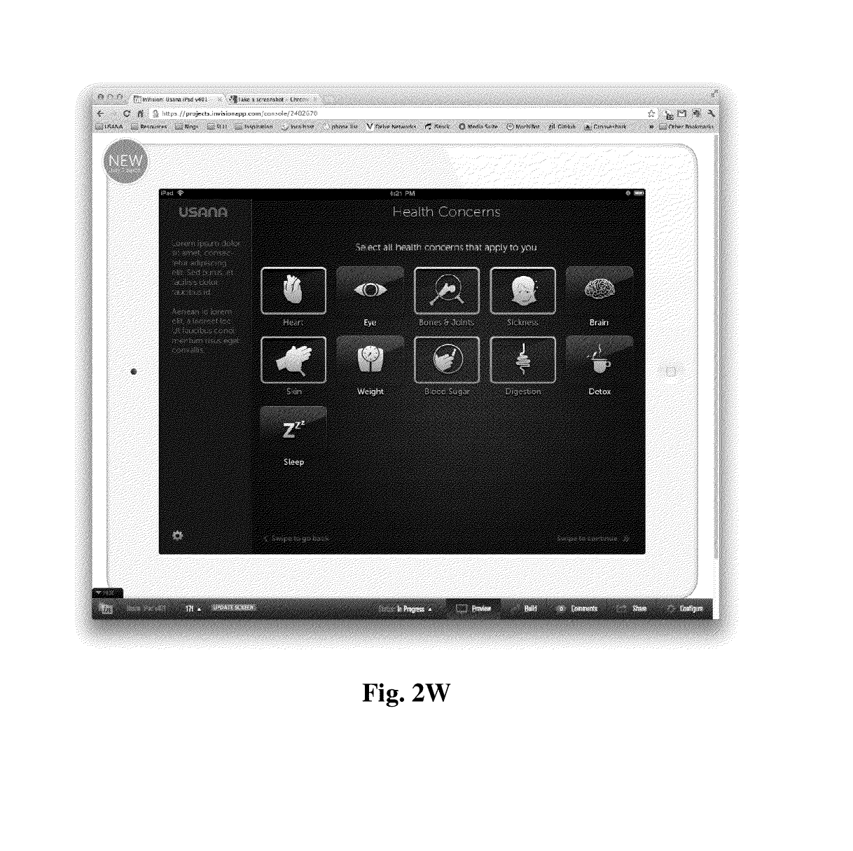

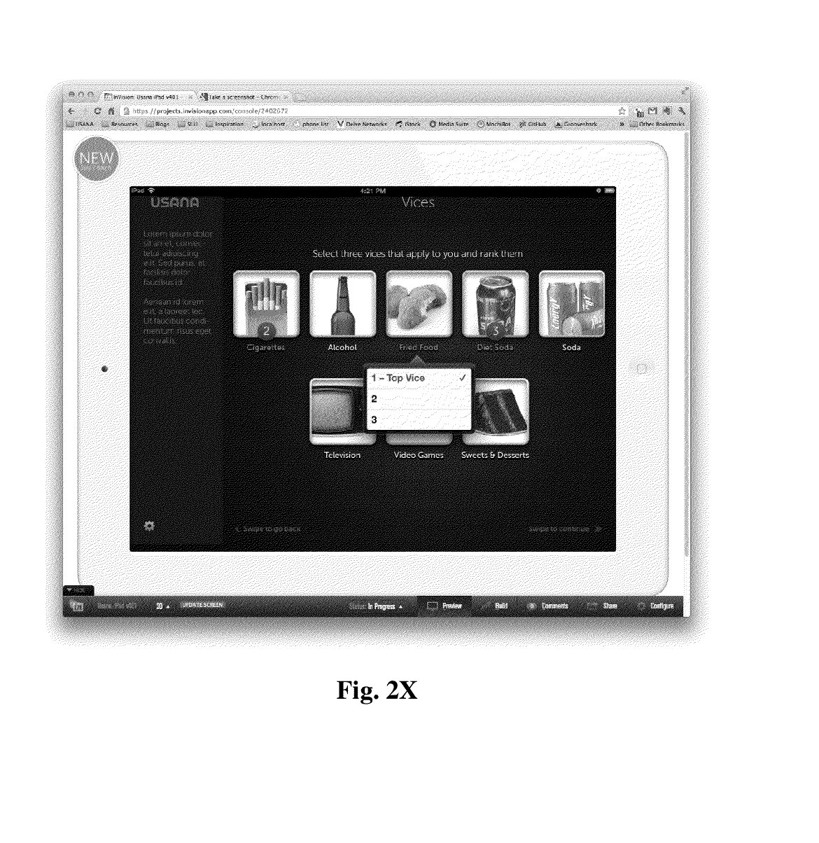

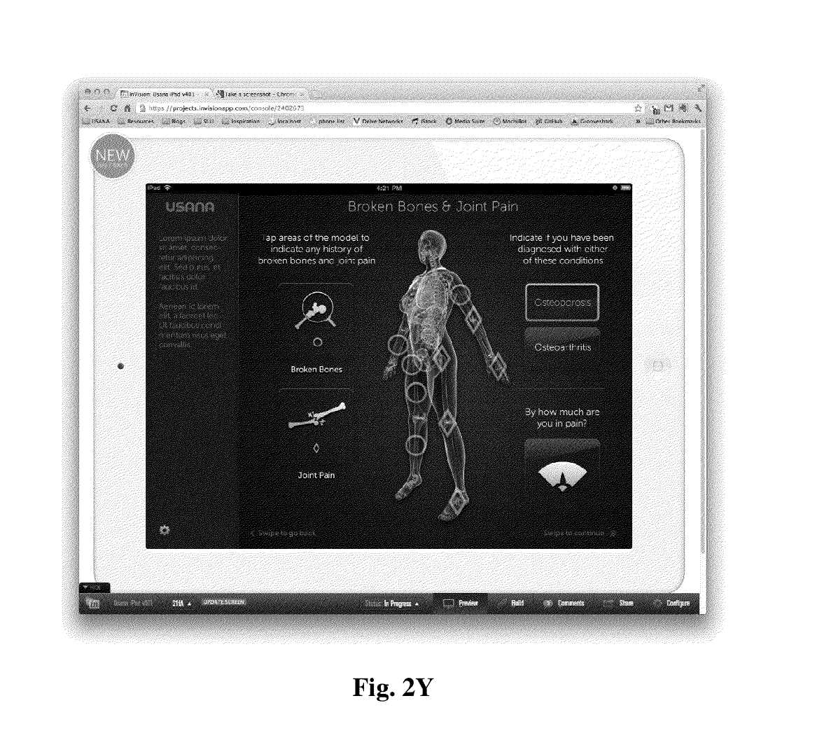

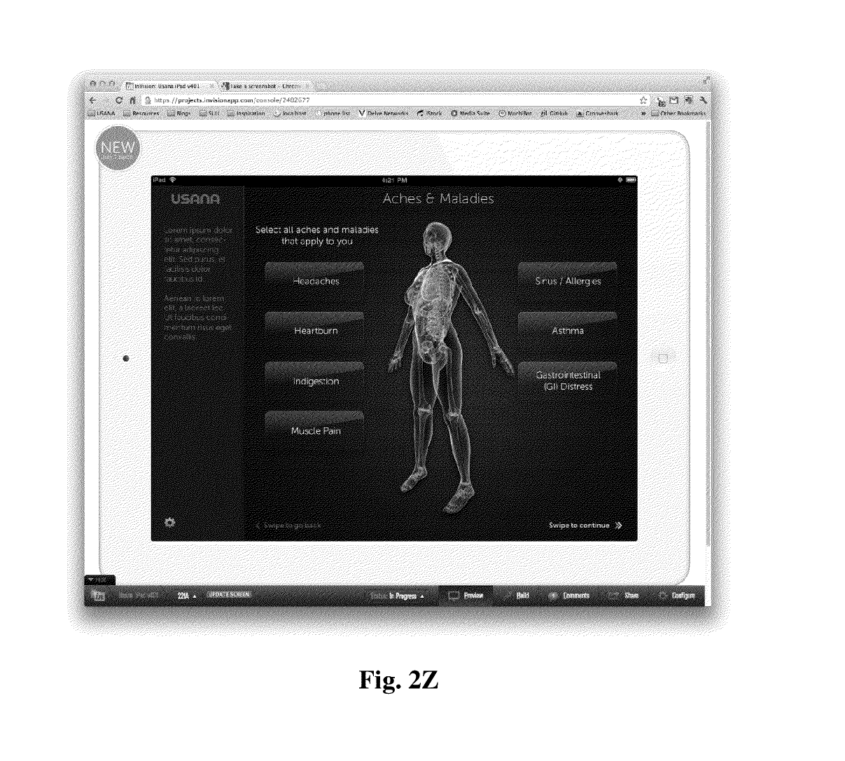

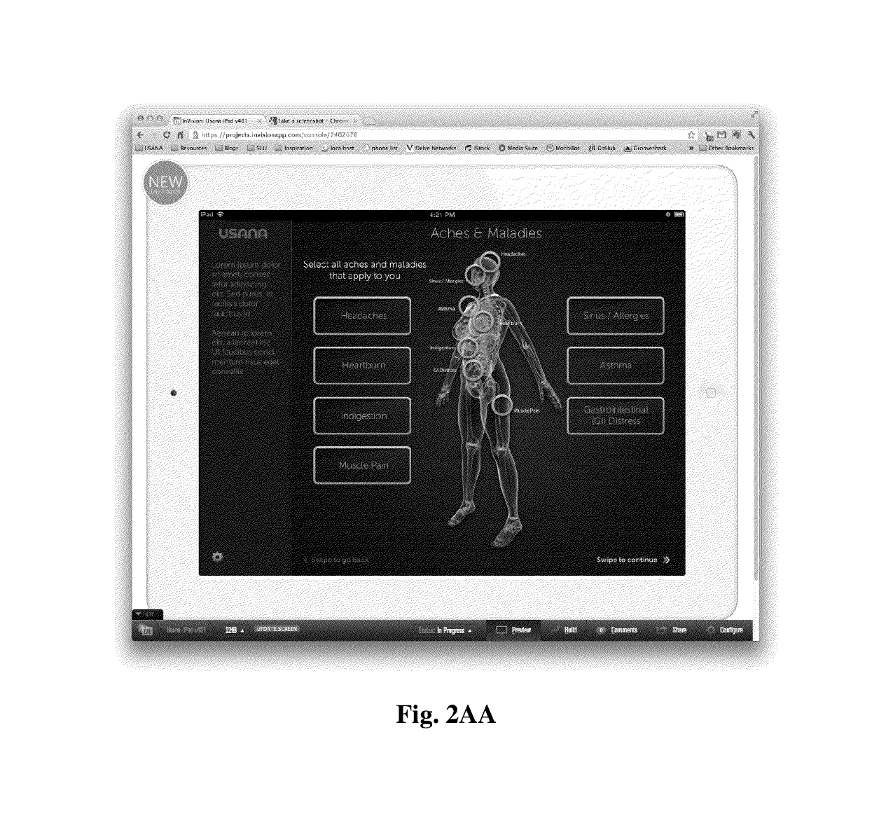

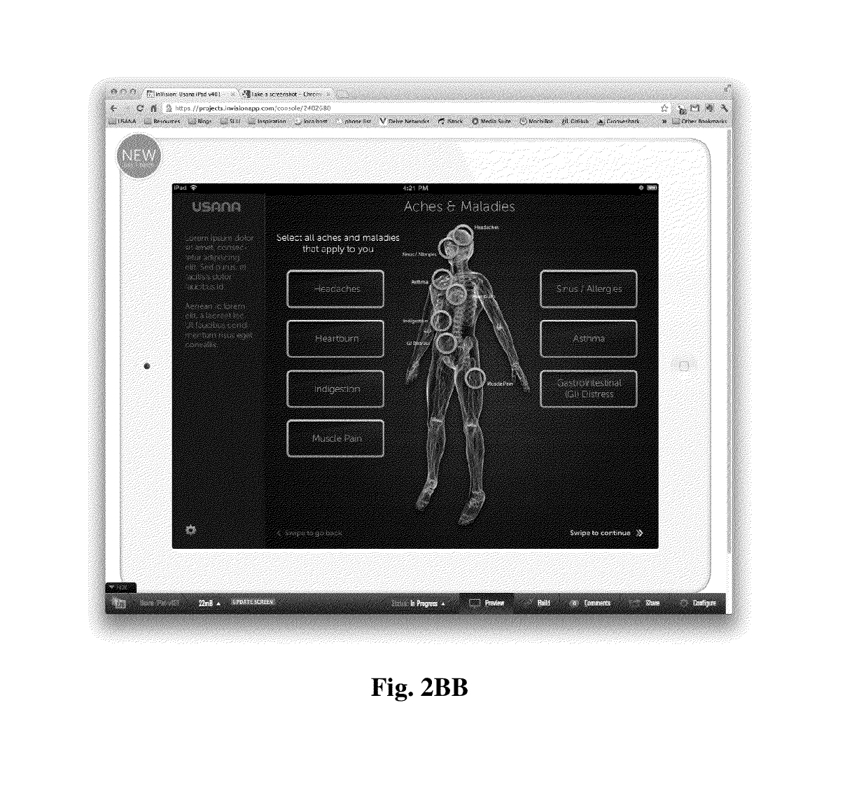

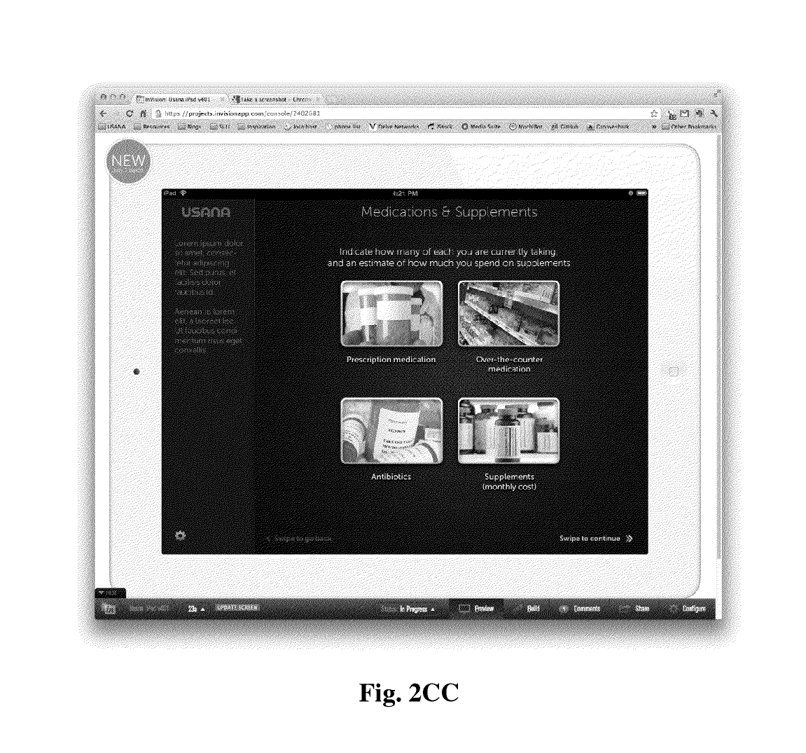

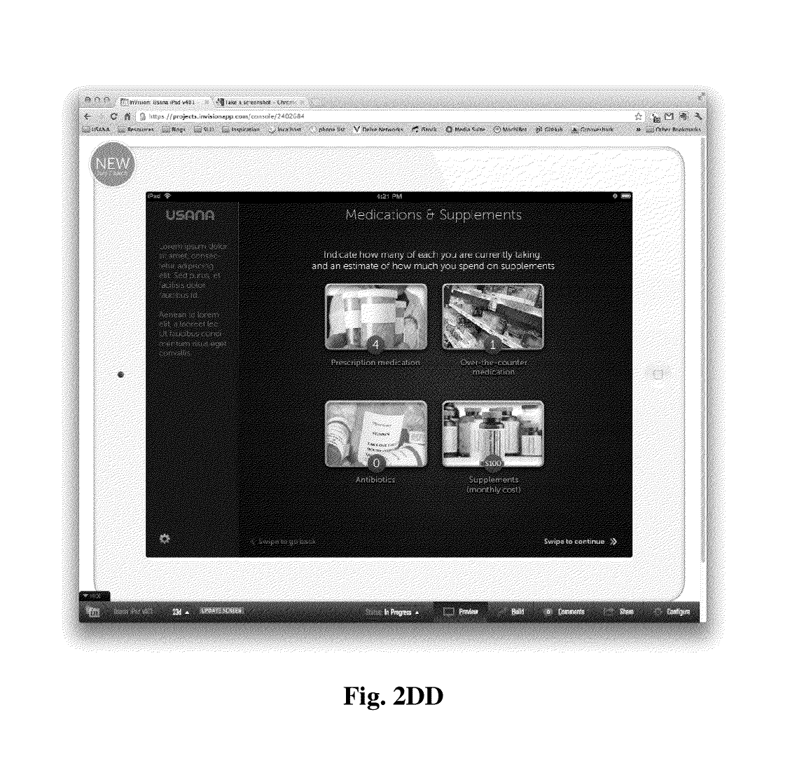

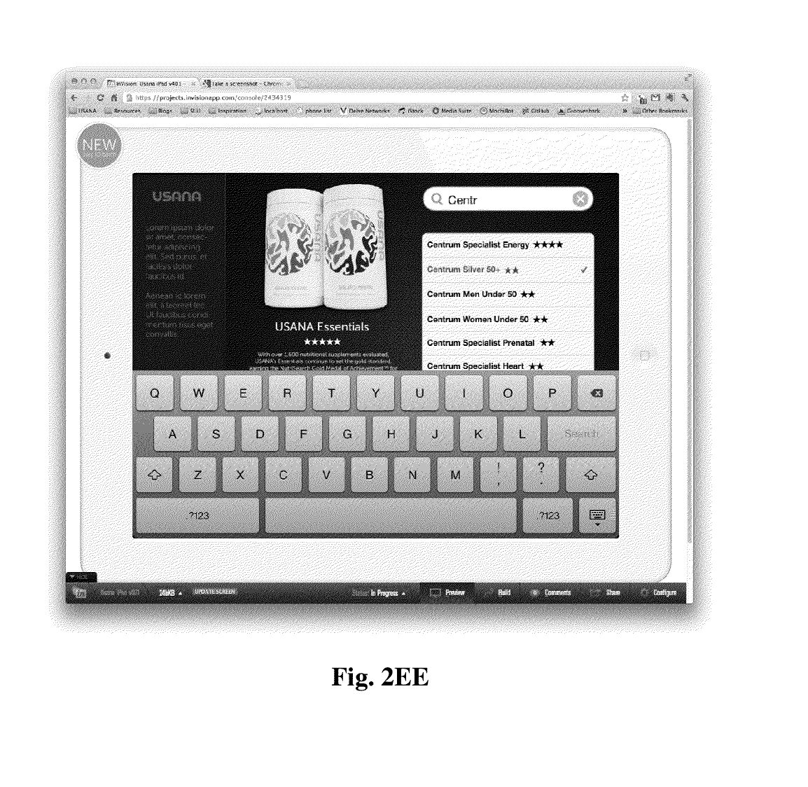

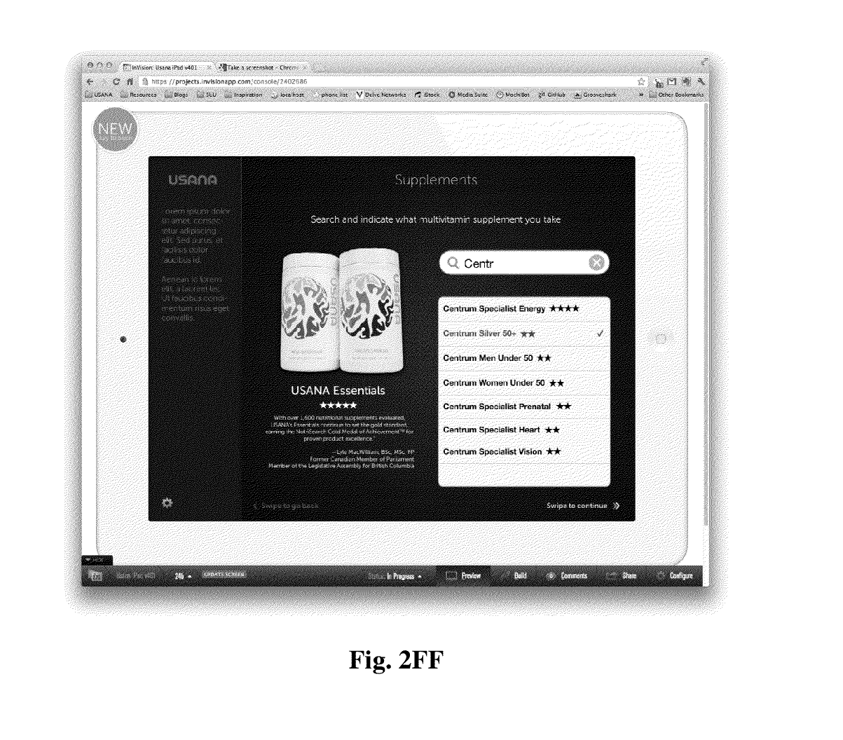

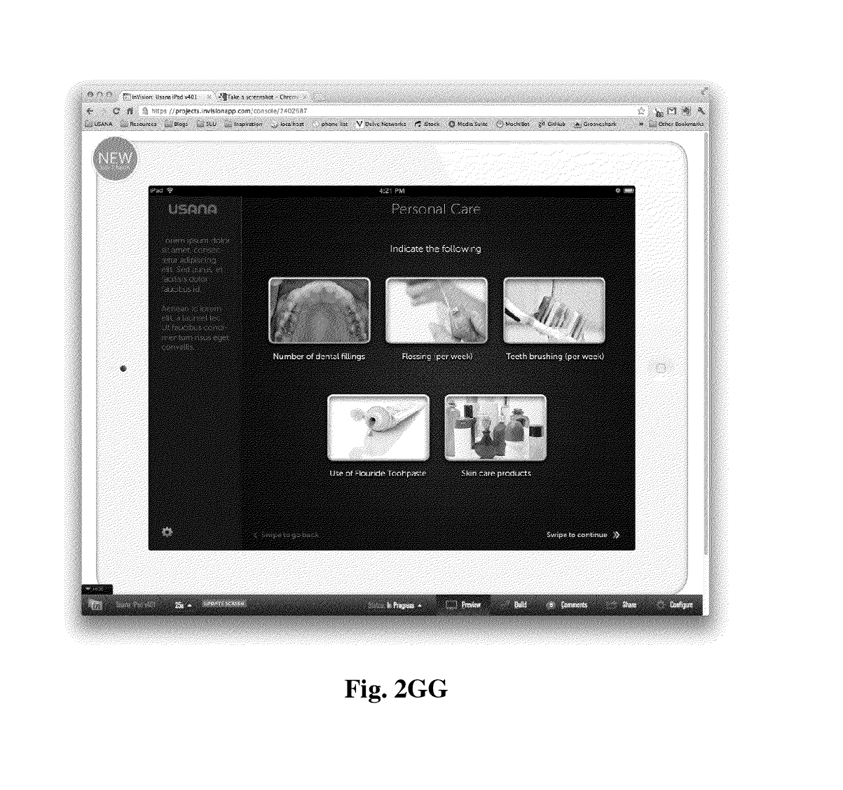

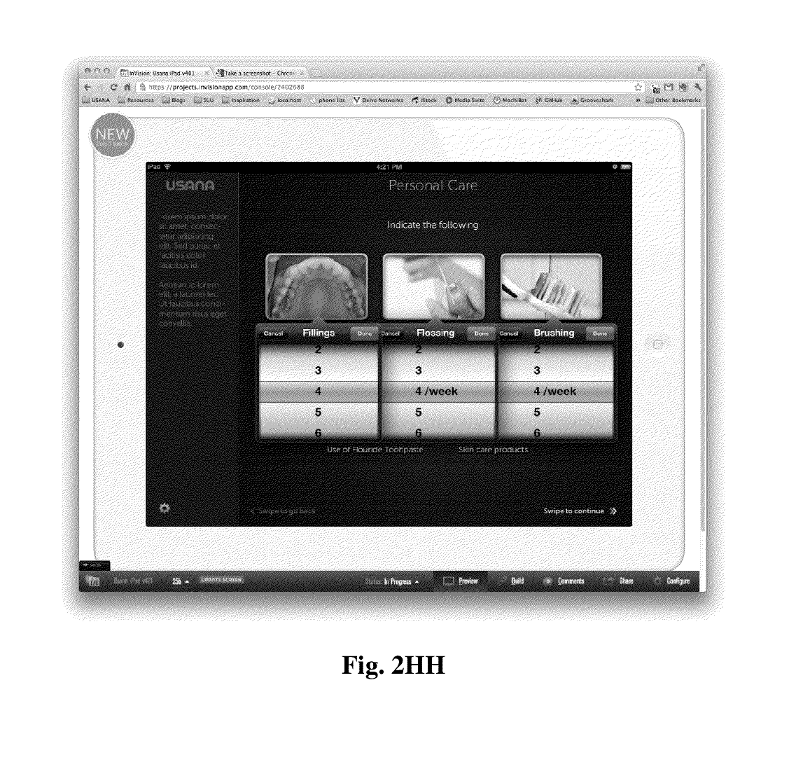

FIGS. 2A-2H illustrate various exemplary views of a user interface that could be displayed to the user during the online health assessment to obtain information from the user. The user provides input to the user interface to respond to various questions or requests.

For example, FIG. 2A provides representations of various health statuses ranging from Hospitalized to Athlete along with sliders to allow the user to specify a current health status and a desired health status by positioning the slider over the appropriate representation.

Additional information can also be obtained via the user interface provided by the online health assessment including demographic information (FIGS. 2B-2G), body measurements (FIGS. 2H-2O), the user's typical day (FIG. 2P), satisfaction and stress level from work (FIG. 2Q), home environment (FIG. 2R), current activity level (FIG. 2S), types of activities (FIG. 2T), food allergies and preferences (FIG. 2U), eating habits (FIG. 2V), health concerns (FIG. 2W), vices (FIG. 2X), injuries, pain, or other issues (FIGS. 2Y-2BB), medications and supplements (FIGS. 2CC-2FF), personal care (FIGS. 2GG-2HH), and exposure and water intake (FIG. 2H). The user interface could also prompt the user for additional information as desired.

Lifestyle, Nutrition, and/or Product Recommendations

The information obtained via the online health assessment can be used to identify lifestyle, nutrition, and/or product changes that the user can make to potentially improve or maintain the user's health status. The identified changes can be presented to the user as lifestyle, nutrition, and/or product recommendations.

In some embodiments, one or more lifestyle, nutrition, and/or product recommendations are selected based on a comparison between the user's current health status and the user's desired health status. For example, if a user indicates that his current health is Average, but would like to have a future health status of Active (as shown in FIG. 2A), the selected recommendations can be different than if the user desires to have a future health status of Athlete.

The selection of lifestyle, nutrition, and/or product recommendations can be based on any number and combination of the user's input data. For example, a hierarchical arrangement (such as a series of if conditions) may be used to drill down (or filter) to a particular recommendation based on the user's input corresponding to many different questions of the health assessment.

In a particular example, if the user indicates that he has a low activity level, an average current health, and a sedentary job, it can then be determined whether the user has a BMI and a belly circumference over a certain amount. If the user matches each of these criteria, a particular recommendation can be provided. In contrast, if the user matches only a subset of the criteria, other determinations can be made (e.g. a stress level in excess of some threshold) to identify a particular recommendation that best matches the user's status and goals.

Risk Areas

The information obtained via the online health assessment can also be used to identify one or more risk areas in the user's lifestyle. For each risk area, one or more suggestions or lifestyle, nutrition, and/or product recommendations can also be identified to inform the user of changes he can make to reduce the risk to his health in the identified risk areas.

In some embodiments, the determination of a risk area in a user's lifestyle can be made based on user input that describes the user's lifestyle. For example, a score can be calculated for each of a number of health areas such as heart, toxins, weight/type 2 diabetes, dementia/mental acuity, immune system, respiratory and allergies, stress, bone and joint, dental, skin, and digestive. Each score can be generated using various components of the user input in a particular calculation.

In some embodiments, the score for each of these areas can be displayed to the user with an indication of which areas pose the greatest risk to future health. The scores can be displayed in various manners including, for example, using a meter.

When an area is identified as posing a potential risk to future health, information can be selected to be displayed to the user to educate the user regarding the risk. The information that is selected can be determined based on the individual scores for the areas. Each area may be associated with a set of information identifying many different potential risks in the area. Based on the user input, and the scores generated from the user input, the set of information can be filtered to identify the most relevant information to provide to the user.

For example, if two users were both identified as having high risk in the heart health area, but the reasons for the high risk were different, the information generated to display for each user could be custom tailored to better address the reasons for a particular user's high risk. In a specific example, if one user has high risk due to hereditary factors, whereas the other user has high risk due to physical characteristics, the information selected to be displayed to each user could be different to better educate the users in accordance with their unique circumstances.

Conditional Logic

In determining which information should be included in a lifestyle, nutrition, and/or product plan for an individual, the online health assessment can apply conditional logic to the information collected about the individual during the online health assessment. In this manner, a tailored lifestyle, nutrition, and/or product plan can be provided to the individual based not only on the individual's current health status but also on the individual's desired future health status. The conditional logic can be applied hierarchically to identify appropriate content.

Initially, conditional logic can be used to identify a difference between the individual's current and desired health. For example, based on individual's input to the user interface shown in FIG. 2A, a value can be assigned to a current health variable and to a future health variable to represent the individual's current and desired health status. In some embodiments, the value can be an integer within a range of health statuses (e.g. 1 for hospitalized-5 for athlete).

Based on the difference between the current health and future health variables, introductory content can be identified for inclusion in the lifestyle, nutrition, and/or product plan. Section A of the Appendix lists various pieces of introductory content that can be included based on the values of the two variables in accordance with one specific implementation of the invention.

Conditional logic can also be used to identify content related to physical activity for inclusion in the lifestyle plan. This activity content can be identified based on various information obtained from the individual during the online health assessment.

Section B of the appendix lists various pieces of activity information along with the conditional logic used to determine whether to include a piece of information in an individual's lifestyle, nutrition, and/or product plan. The conditional logic can use the value of one or of a combination of variables to determine whether a particular piece of information is to be included in the lifestyle, nutrition, and/or product plan including: a specified activity level, whether the individual is pregnant, a current health status, whether the individual has osteoporosis, the degree to which the individual's profession is sedentary, physical measurements of the individual, age of the individual, a specified stress level, whether the individual is married or has children, a desired future health status, types of activity the individual performs, or pain that the individual experiences.

In some embodiments, a combination of the values for a specified activity level, current health status, and the degree to which the individual's profession is sedentary can be used to determine an initial categorization from which activity information will be selected. After applying the conditional logic to these three values, further conditional logic can then be applied to values of other variables such as the BMI and belly circumference of the individual, the future health, stress level, and marriage and children status of the individual, etc.

Further customizations can be made based on the types of activities the individual participates in. For example, a different recommendation can be provided to an individual that engages in a lot of cardio exercise than to an individual that engages in a lot of weight bearing exercise. Similar customizations could also be made based on the number of types of exercise the individual engages in. In this manner, the most relevant activity information can be selected based on the individual's specific characteristics.

Section C of the appendix lists various pieces of toxic burden information along with the conditional logic used to determine whether to include a piece of information in an individual's lifestyle, nutrition, and/or product plan. Customized toxic burden information can be selected based on the individual's living environment, vices, medications taken, personal care or other products used, dental health, age, or type of water consumed. Various combinations of these factors can be used to identify relevant information.

For example, a recommendation regarding personal care products can be custom tailored based on the age of the individual. Similarly, a recommendation regarding water to consume can be custom tailored based on the type of water the individual currently consumes and the type of toothpaste the individual uses.

Section D of the appendix lists various pieces of diet information along with the conditional logic used to determine whether to include a piece of information in an individual's lifestyle, nutrition, and/or product plan. Customized diet information can be selected based on various factors as shown in the appendix. For example, diet information can be selected based on how much fried food the individual consumes, or a combination of how much high-glycemic food the individual consumes and the BMI or waist measurement of the individual. Various other pieces of information can be selected based on what, how, and when the individual eats, among other factors.

Section E of the appendix lists various pieces of genetics/biometrics information along with the conditional logic used to determine whether to include a piece of information in an individual's lifestyle, nutrition, and/or product plan. Genetics/biometrics information can be selected based on various factors including the individual's gender, race, family history, activity level, vices, measurements, etc.

For example, the conditional logic may be used initially to determine whether the individual is a male or female prior to applying further conditional logic to identify specific pieces of genetics/biometrics information for inclusion in the lifestyle, nutrition, and/or product plan. Initial conditional logic may also be applied to filter out irrelevant information based on the individual's ethnicity.

Section F of the appendix lists various pieces of stress information along with the conditional logic used to determine whether to include a piece of information in an individual's lifestyle, nutrition, and/or product plan. Recommendations for lowering an individual's stress level can be customized based on the individual's stated stress level. Further customization can be performed based on the individual's level of job satisfaction, marriage or children status, and amount of sleep.

Accordingly, the present invention enables the creation of a custom tailored lifestyle, nutrition, and/or product plan by employing conditional logic to operate on various numbers and combinations of factors derived from the individual's responses during the online health assessment.

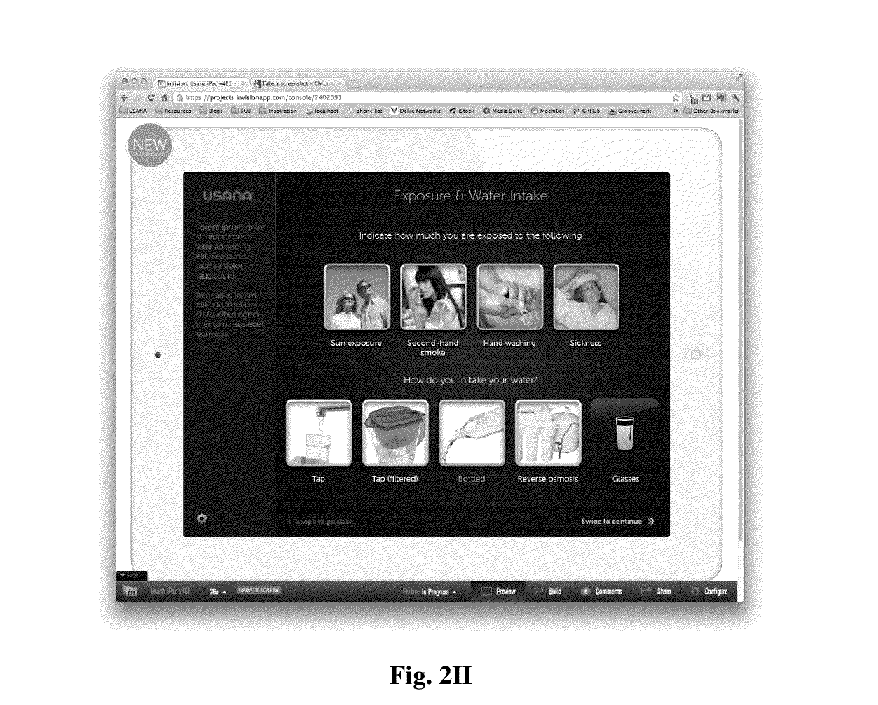

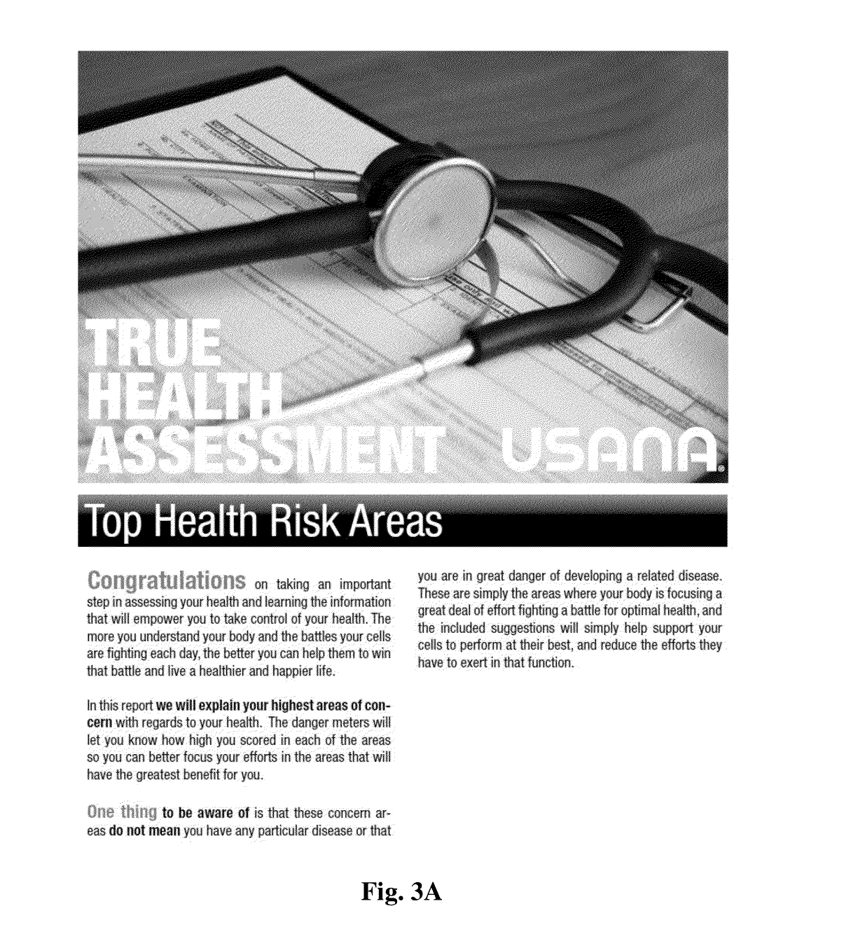

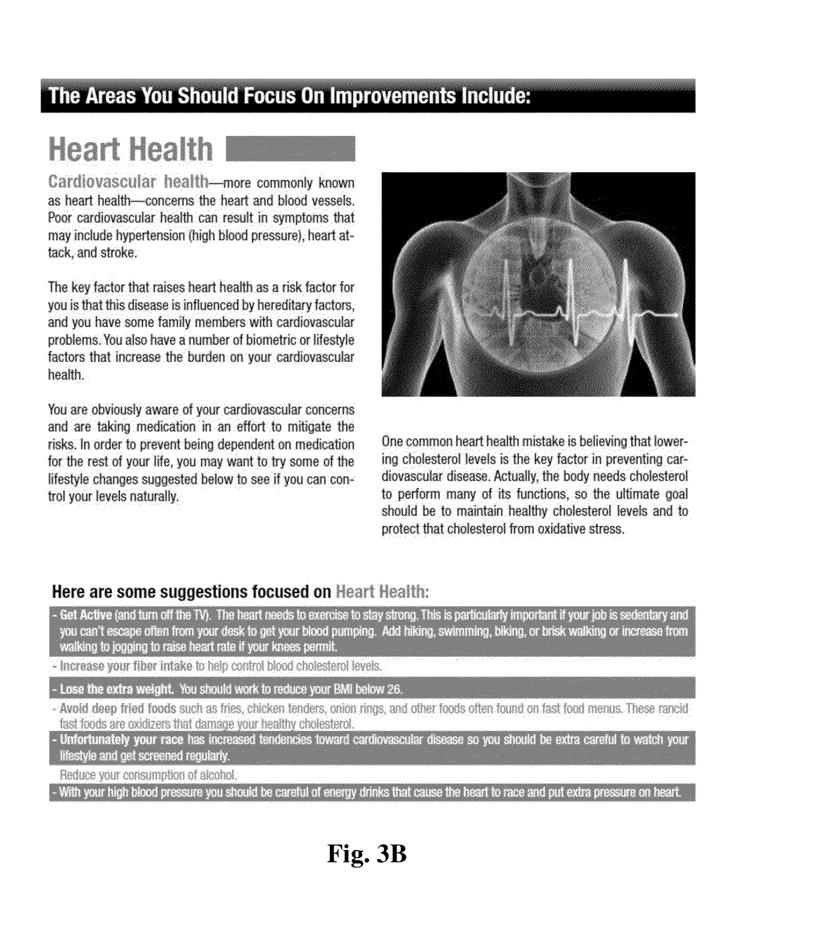

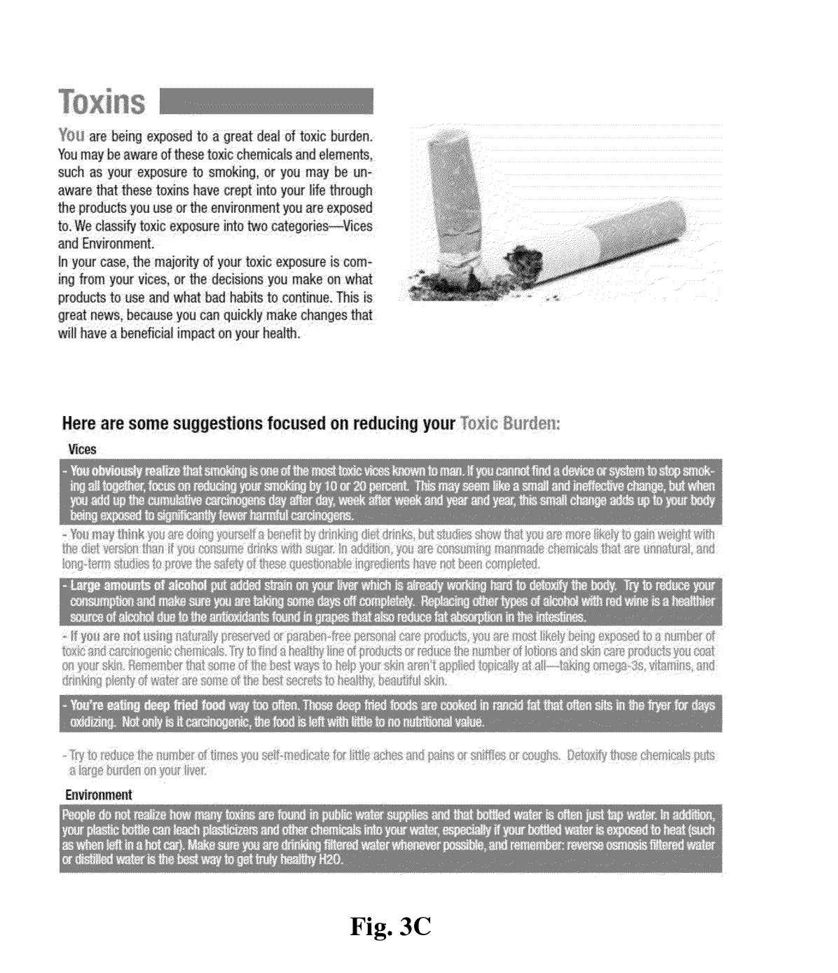

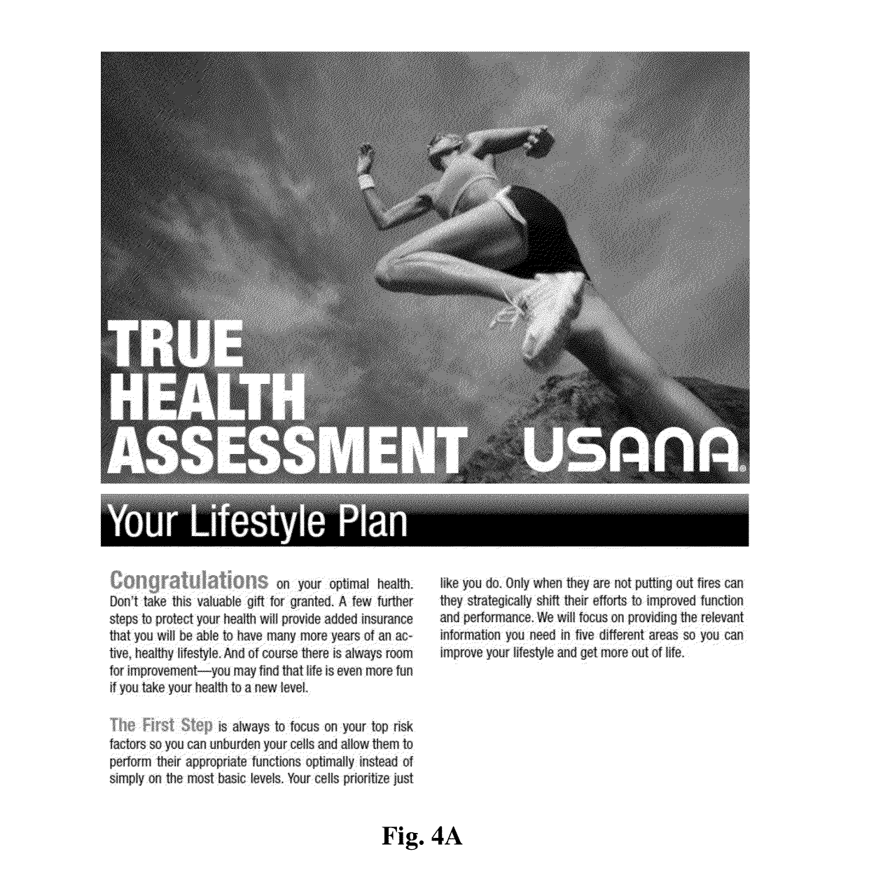

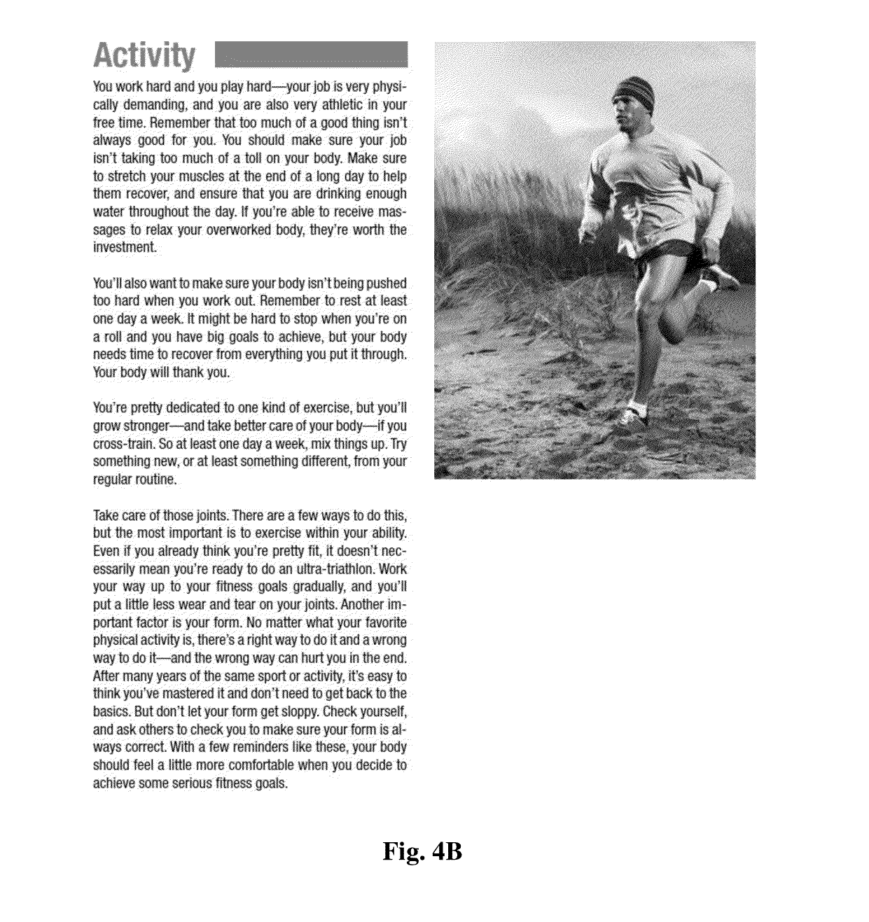

FIGS. 3A-3C and 4A-4C illustrate portions of a lifestyle plan that includes customized information that was selected using the conditional logic of the present invention. FIGS. 3A-3C display various risk areas, whereas FIGS. 4A-4C display various lifestyle recommendations that were identified based on the individual's input.

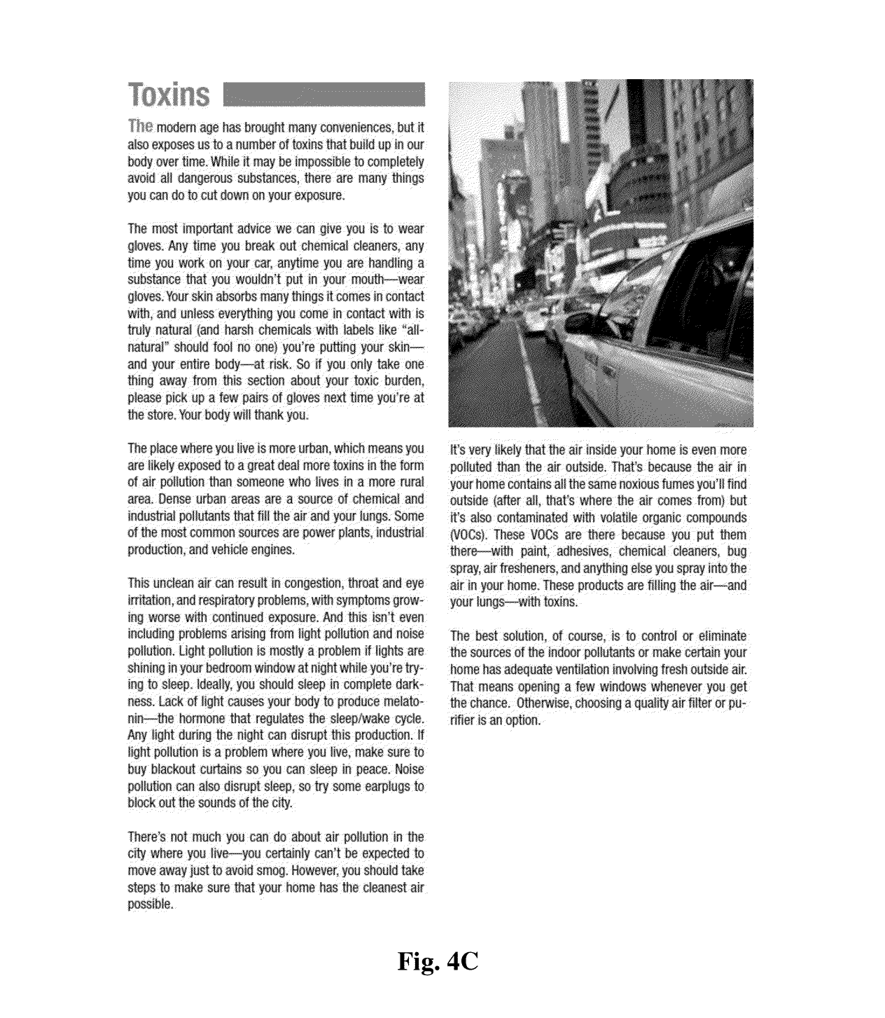

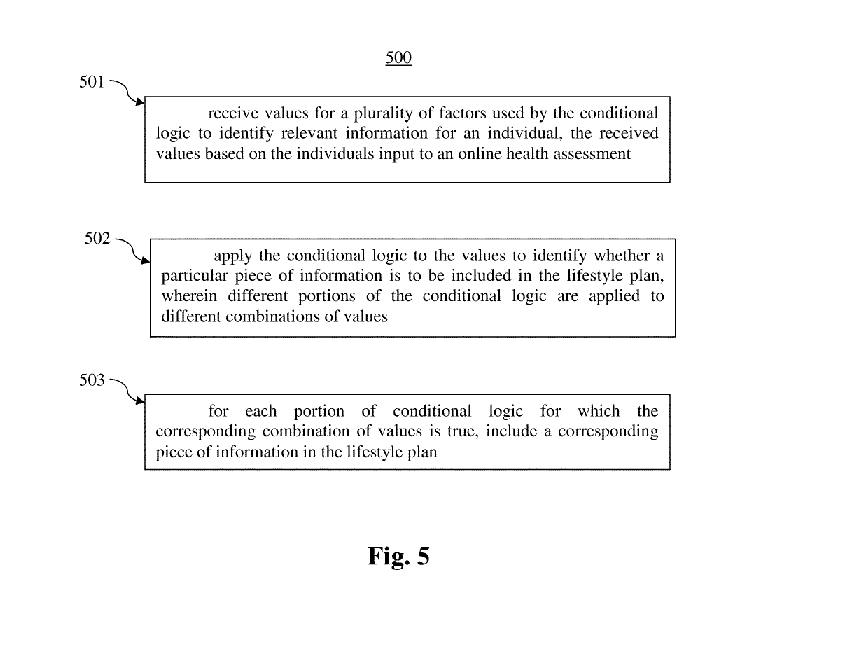

FIG. 5 illustrates a flowchart of an exemplary method 500 for using conditional logic to identify relevant information to include in a lifestyle, nutrition, and/or product plan of an individual. Method 500 includes an act 501 of receiving values for a plurality of factors used by the conditional logic to identify relevant information for an individual, the received values based on the individuals input to an online health assessment.

Method 500 includes an act 502 of applying the conditional logic to the values to identify whether a particular piece of information is to be included in the lifestyle, nutrition, and/or product plan, wherein different portions of the conditional logic are applied to different combinations of values.

Method 500 includes an act 503 of, for each portion of conditional logic for which the corresponding combination of values is true, including a corresponding piece of information in the lifestyle, nutrition, and/or product plan.

In some embodiments, one or more products can also be recommended to assist the user in addressing a risk or following a lifestyle plan. For example, if a user is identified as having high risk in the heart health area, a suggestion can be provided to lose weight along with a recommended workout schedule and one or more supplements to assist in weight loss. In instances where a product is recommended to the user, the user may be provided with a mechanism to visit a seller of the product, such that the user may readily and quickly acquire the desired product. For example, the user may be provided with a direct link to a website selling the particular product recommended to the user. In some examples, a seller of products may be the provider of the health assessment, and recommendations provided by the health assessment may result in profits to the seller as users of the health assessment are recommended products sold by the seller.

The online health assessment can be provided in various forms including as a webpage accessible via a typical web browser or as a mobile application for a smart phone. In some embodiments, the format of the generated lifestyle plan can be determined based on the type of device the user is using to take the online health assessment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. In a computer system, a method for using conditional logic to identify relevant information to include in a lifestyle plan of an individual, the method comprising:
receiving values for a plurality of factors used by the conditional logic to identify relevant information for an individual, the received values based on the individuals input to an online health assessment;
applying the conditional logic to the values to identify whether a particular piece of information is to be included in the lifestyle plan, wherein different portions of the conditional logic are applied to different combinations of values; and
for each portion of conditional logic for which the corresponding combination of values is true, including a corresponding piece of information in the lifestyle plan.

2. The method of claim 1, wherein the conditional logic is arrange hierarchically.

3. The method of claim 2, wherein the hierarchical arrangement is based on specified values of at least some of the factors.

4. The method of claim 3, wherein the at least some factors comprise a current health status and a desired future health status of the individual.

5. The method of claim 1, wherein the relevant information is selected from among various classes of information.

6. The method of claim 5, wherein the classes of information include activity information, toxic burden information, diet information, genetics/biometrics information, and stress information.

7. The method of claim 6, wherein a particular piece of activity information is identified based on a combination of values for a specified activity level, a current health status, and a degree to which the individual's profession is sedentary.

8. The method of claim 7, wherein a particular piece of activity information is further identified based on one or more of a BMI or belly circumference of the individual, a desired future health of the individual, a stress level of the individual, or a marriage or children status of the individual.

9. The method of claim 7, wherein a particular piece of activity information is further identified based on the type of activities the individual engages in.

10. The method of claim 6, wherein a particular piece of toxic burden information is identified based on the individual's living environment, vices, medications taken, personal care or other products used, dental health, age, or type of water consumed.

11. The method of claim 10, wherein a particular piece of toxic burden information is further identified based on a combination of personal products used and an age of the individual.

12. The method of claim 6, wherein a particular piece of diet information is identified based on a combination of what, how and when an individual eats.

13. The method of claim 12, wherein a particular piece of diet information is further identified based on a combination of the type of food the individual eats and the BMI or waist measurement of the individual.

14. The method of claim 6, wherein a particular piece of genetics/biometrics information is identified based on a combination of two or more of the individual's gender, race, family history, activity level, vices, or measurements.

15. The method of claim 14, wherein the conditional logic is hierarchically arranged to categorize the genetics/biometrics information based on the gender or ethnicity of the individual.

16. The method of claim 6, wherein a particular piece of stress information is identified based on the individual's stated stress level.

17. The method of claim 1, further comprising:
displaying the lifestyle plan.

18. In a computer system, one or more computer storage media storing computer executable instructions for implementing a method for using conditional logic to identify relevant information to include in a lifestyle plan of an individual, the method comprising:
receiving values for a plurality of factors used by the conditional logic to identify relevant information for an individual, the received values based on the individuals input to an online health assessment;
applying the conditional logic to the values to identify whether a particular piece of information is to be included in the lifestyle plan, wherein different portions of the conditional logic are applied to different combinations of values; and
for each portion of conditional logic for which the corresponding combination of values is true, including a corresponding piece of information in the lifestyle plan.

19. The one or more computer storage media of claim 18, wherein the conditional logic is arrange hierarchically.

20. The one or more computer storage media of claim 19, wherein the hierarchical arrangement is based on specified values of at least some of the factors.
